(19) United States
(12) Patent Application Publication
(10) Pub. No.: US 2024/0338012 A1
(43) Pub. Date: Oct. 10, 2024

(54) PREMISES ENVIRONMENT PLATFORM WITH MULTI-SYSTEM BATTERY BACKUP FUNCTIONALITY

(71) Applicant: TYCO Fire & Security GMBH, Schaffhausen (CH)

(72) Inventors: Rajmy SAYAVONG, Cambridge (CA); Allen Ly, Richmond Hill (CA); Stephen D. Fosty, Brampton (CA); George C. Grzeslo, Etobicoke (CA)

(21) Appl. No.: 18/627,242

(22) Filed: Apr. 4, 2024

Related U.S. Application Data
(60) Provisional application No. 63/457,027, filed on Apr. 4, 2023.

(51) Int. Cl. G05B 19/418

(52) U.S. Cl. CPC G05B 19/4184; G05B 2219/34073

(57) ABSTRACT

Some non-limiting aspects of the present disclosure allow a single box to implement a control panel for controlling two or more safety/automation systems (e.g., fire protection, intrusion, access control, building controls, etc.), while also meeting standby and/or other battery backup requirements of each one of the safety/automation systems.

### CROSS REFERENCE TO RELATED APPLICATION(S)

This application claims priority to U.S. Provisional Application Ser. No. 63/457,027, entitled “PREMISES ENVIRONMENT PLATFORM WITH MULTI-SYSTEM BATTERY BACKUP FUNCTIONALITY” and filed on Apr. 4, 2023, which is expressly incorporated by reference herein in the entirety.

### FIELD

The present disclosure relates generally to premises safety/automation systems, and more specifically, to providing battery backup for a premises safety/automation system.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

An example aspect includes a control panel configured to control two or more premises safety or automation systems of a premises. The control panel comprises a first connection connectable to supply power to one or more first devices of a first premises safety or automation system having a first standby time requirement. The control panel further comprises a second connection connectable to supply power to one or more second devices of a second premises safety or automation system having a second standby time requirement that is less than the first standby time requirement. The control panel further comprises one or more processors that, individually, as a subgroup, or in combination, are configured to enter a standby mode in which the first connection and the second connection supply battery backup power to the one or more first devices of the first premises safety or automation system and the one or more second devices of the second premises safety or automation system. The one or more processors, individually, as a subgroup, or in combination, are further configured to disconnect the second connection to cease supplying the battery backup power to the one or more second devices of the second premises safety or automation system upon expiration of the second standby time requirement, while keeping the first connection to continue supplying the battery backup power to the one or more first devices of the first premises safety or automation system.

Another example aspect includes a control panel configured to control two or more premises safety or automation systems of a premises. The control panel comprises a first connection connectable to supply power to one or more first devices of a first premises safety or automation system having a first standby time requirement. The control panel further comprises a second connection connectable to supply power to one or more second devices of a second premises safety or automation system having a second standby time requirement that is less than the first standby time requirement. The control panel further comprises one or more processors that, individually, as a subgroup, or in combination, are configured to enter a standby mode in which the first connection and the second connection supply battery backup power to the one or more first devices of the first premises safety or automation system and the one or more second devices of the second premises safety or automation system. The one or more processors, individually, as a subgroup, or in combination, are further configured to determine, upon expiration of the second standby time requirement, whether a current drawn by the second premises safety or automation system is greater than a threshold. The one or more processors, individually, as a subgroup, or in combination, are further configured to disconnect the second connection to cease supplying the battery backup power to the one or more second devices of the second premises safety or automation system responsive to expiration of the second standby time requirement and the current being greater than the threshold, while keeping the first connection to continue supplying the battery backup power to the one or more first devices of the first premises safety or automation system.

A further example aspect includes a control panel configured to control two or more premises safety or automation systems of a premises. The control panel comprises a first connection connectable to supply power to one or more first devices of a first premises safety or automation system having a first standby time requirement. The control panel further comprises a second connection connectable to supply power to one or more second devices of a second premises safety or automation system having a second standby time requirement equal to the first standby time requirement. The control panel further comprises one or more processors that, individually, as a subgroup, or in combination, are configured to enter a standby mode in which the first connection and the second connection supply battery backup power to the one or more first devices of the first premises safety or automation system and the one or more second devices of the second premises safety or automation system. The one or more processors, individually, as a subgroup, or in combination, are further configured to determine, upon expiration of the second standby time requirement, whether the first premises safety or automation system has a higher standby priority than the second premises safety or automation system. The one or more processors, individually, as a subgroup, or in combination, are further configured to disconnect the second connection, responsive to the first premises safety or automation system having the higher standby priority than the second premises safety or automation system, to cease supplying the battery backup power to the one or more second devices of the second premises safety or automation system, while keeping the first connection to continue supplying the battery backup power to the one or more first devices of the first premises safety or automation system. The one or more processors, individually, as a subgroup, or in combination, are further configured to disconnect the first connection, responsive to the second premises safety or automation system having the higher standby priority than the first premises safety or automation system, to cease supplying the battery backup power to the one or more first devices of the first premises safety or automation system, while keeping the second connection to continue supplying the battery backup power to the one or more second devices of the second premises safety or automation system.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a schematic diagram of an example premises environment platform including a control panel configured for combining a fire protection system with one or more other safety/automation systems, according to some aspects of the present disclosure;

FIG. 2 is a schematic diagram of an example user flow of the example premises environment platform of FIG. 1, according to some aspects of the present disclosure;

FIG. 3 is a block diagram of an example of the control panel of FIG. 1 providing battery backup for a fire protection system and another safety/automation system, according to some aspects of the present disclosure;

FIG. 4 is a schematic diagram of an example battery circuit, according to some aspects of the present disclosure;

FIG. 5 is a block diagram of an example control panel start up routine, according to some aspects of the present disclosure;

FIG. 6 is a flow diagram of an example dual battery charge routine, according to some aspects of the present disclosure;

FIG. 7 is a flow diagram of an example battery discharge routine, according to some aspects of the present disclosure;

FIG. 8 is a block diagram of an example computing device which may implement all or a portion of any component or functionality in FIGS. 1-7 and/or in FIGS. 9-11, according to some aspects of the present disclosure;

FIG. 9 is a flow diagram of an example battery management method for disconnecting one system to ensure sufficient standby time for another system, according to some aspects of the present disclosure;

FIG. 10 is a flow diagram of an example battery management method for using current measurement to determine whether to disconnect one system to ensure sufficient standby time for another system, according to some aspects of the present disclosure; and

FIG. 11 is a flow diagram of an example battery management method for using standby priority information to disconnect one system to ensure sufficient standby time for another system, according to some aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components may be shown in block diagram form in order to avoid obscuring such concepts.

Aspects of the present disclosure allow a single box to implement a control panel for controlling a fire protection system as well as one or more other safety/automation systems (e.g., intrusion, access control, building controls, etc.), while also meeting battery backup requirements of the fire protection system and the battery backup requirements of the other safety/automation systems. In some aspects, the control panel includes one or more processors being coupled with one or more components of the fire protection system via a first bus, and being also coupled with one or more components of another safety/automation system via a second bus that is different than the first bus. The control panel may include separate current measurement/control circuitry for independently and/or separately controlling the first bus and the second bus by the one or more processors, individually, as a subgroup, or in combination, such as via execution of instructions stored on one or more memories. In some aspects, unlike some conventional systems in which each safety/automation system has a separate control panel that includes a backup battery for that safety/automation system, the single control panel according to the present aspects executes an algorithm that controls the operation (e.g., load balancing, charging, etc.) of one or more batteries in the control panel to meet battery backup requirements of the fire protection system and another safety/automation system. In some aspects, the control panel according to the present aspects executes an algorithm that selectively disconnects some safety/automation systems to allow for sufficient battery standby time for some other safety/automation systems.

As used herein, a processor, at least one processor, and/or one or more processors, individually, as a subgroup, or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

As used herein, a memory, at least one memory, and/or one or more memories, individually, as a subgroup, or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually, as a subgroup, or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, In combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

Turning now to the figures, example aspects are depicted with reference to one or more components described herein, where components in dashed lines may be optional.

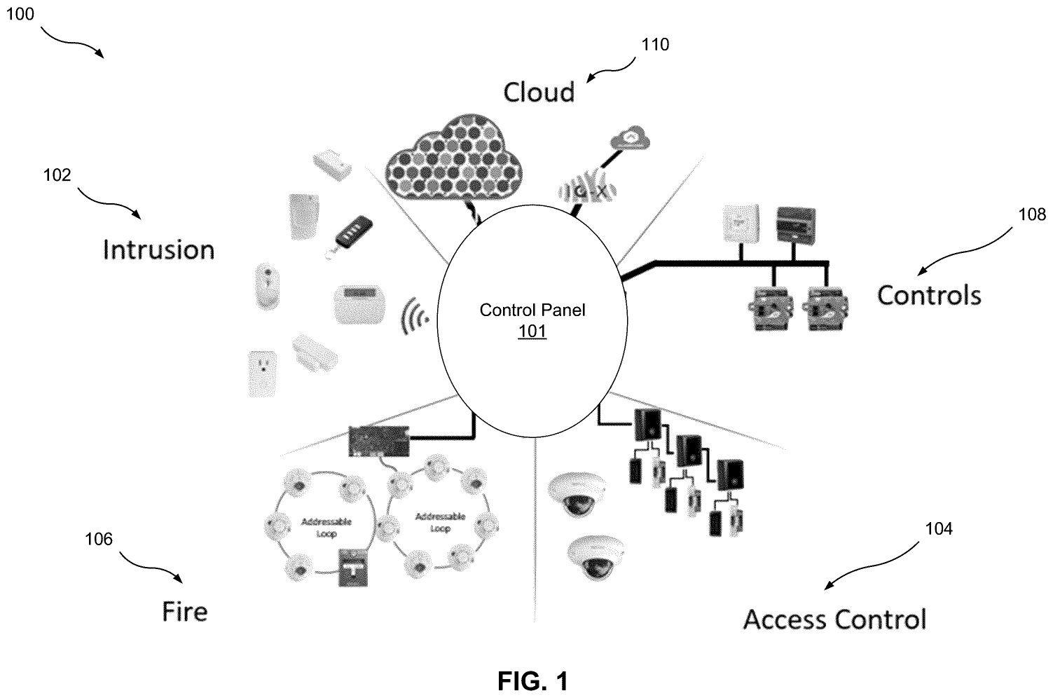

Referring to FIG. 1, in one non-limiting example aspect, a premises environment platform 100 may have a scalable and extensible modular architecture for providing an autonomous building system. The premises environment platform 100 may combine and harmonize various building systems, such as but not limited to a building intrusion/security system 102 configured to detect a potential intruder, an access control system 104 configured to limit access to the premises to authorized persons, a fire protection system 106 configured to detect and indicate potential fire, smoke, or other safety-related events, a building controls system 108 configured to manage one or more of a plurality of devices, components, or functions within the premises, etc.

In one non-limiting example aspect, the premises environment platform 100 may include a control panel 101 that provides not only the functionality of the building intrusion/security system 102 but also receives input data from, and/or controls, various other building devices associated with other systems, such as the fire protection system 106, the access control system 104, the building controls system 108, etc. Examples of the various devices that are communicatively coupled with the control panel 101 may include addressable fire beacon/sounder pull stations, smoke detectors, thermostats, intrusion motion sensors, access card readers, access keypads, door contacts, etc. The control panel 101 may also be communicatively coupled with a cloud system 110 that provides cloud-based support for the operation of the premises environment platform 100 or any of the building systems integrated within the premises environment platform 100 such as the building intrusion/security system 102, the access control system 104, the fire protection system 106, the building controls system 108, etc.

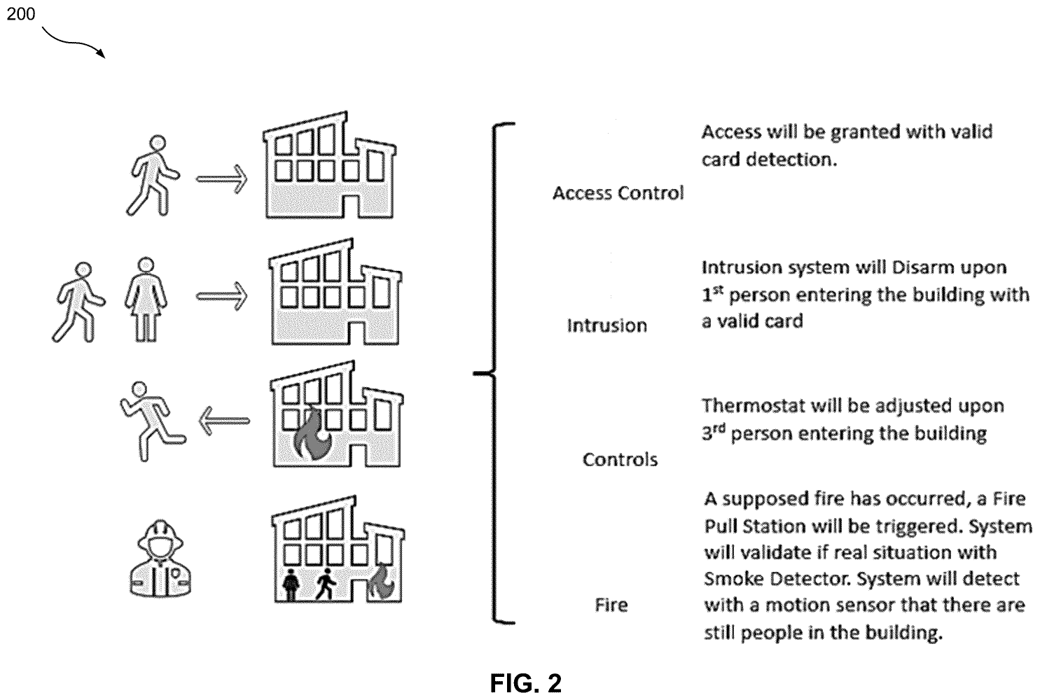

Referring to FIG. 2, in one non-limiting aspect, an example user flow 200 of the operation of the premises environment platform 100 (e.g., in a small business environment) may combine/integrate the functionality of a building access system with the functionality of the building fire system and the building heating, ventilation, and air conditioning (HVAC) system. For example, the access control system may grant access with a valid card detection. Then, the intrusion/security system may disarm upon a first person entering the building with a valid card. Then, the building controls may adjust a thermostat upon a third person entering the building. Then, if a supposed fire occurs and a fire pull station is triggered, the fire protection system may validate if the fire is real, for example, based on the output of one or more smoke detectors. The system may also detect, e.g., based on motion detection by a motion sensor, that there are still people in the building.

The premises environment platform 100 may provide various customer results/outcomes, such as reduced cost of ownership (e.g., energy savings, operational savings, water savings, increased carbon offsets, etc.), improved operational efficiency (e.g., healthy building indicator, occupancy mapping, heat mapping for HVAC systems, etc.), prevention (e.g., advanced emergency medical service (EMS)/life safety, early system failures, false alarms, etc.), tenant satisfaction (e.g., clear and healthy air, safe environments, hassle free to focus on tasks, etc.), smart and connected environment (e.g., cloud analytics, leveraging external data (e.g., weather, local energy costs, etc.), services, etc.), etc.

The customers may be, for example, direct customers that are people who are directly associated with the building, such as workers working inside the building, a company or tenant in a multi-dwelling unit, property managers, building owners, etc. The customers may also be indirect customers such as people who would indirectly benefit from the premises environment platform 100.

The customer outcomes of the premises environment platform 100 may drive opportunities for services. For example, the premises environment platform 100 may provide a dashboard that illustrates various graphs of operational data such as energy utilization, utilization mapping, and operating costs/savings, to a property manager or owner. Such information may be used, for example, to determine the monthly rent rates for the units in a building. Accordingly, the premises environment platform 100 may provide a foundation for services related to energy. Similar functionality may be implemented for water usage, for example.

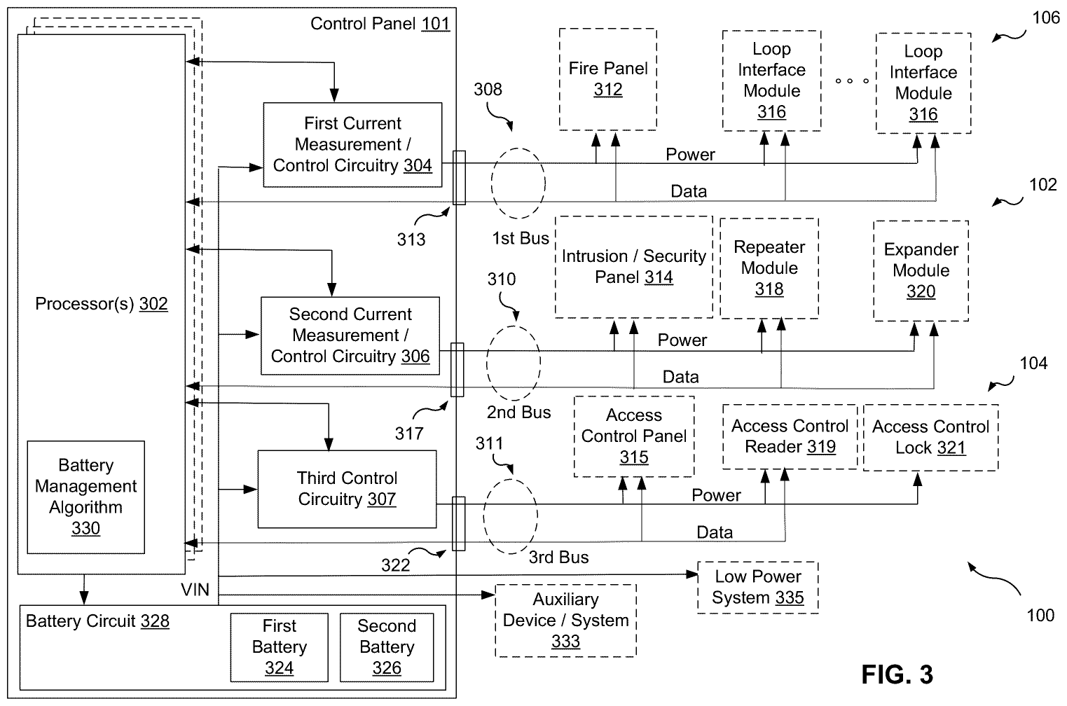

Referring to FIG. 3, in some non-limiting example aspects, the control panel 101 of the premises environment platform 100 may include hardware aspects to support and/or combine a fire protection system 106 and one or more other safety/automation systems, where the one or more other safety/automation systems may include, but are not limited to, an intrusion/security system 102, a premises automation system (not shown), an access control system 104, a building controls system (not shown), etc. In order to have the fire protection system 106 and the other safety/automation systems (e.g., 102, 104) provided by the hardware in a single box (the control panel 101), there are certain considerations to take into account in order to meet the fire code standards. For example, in some aspects, the hardware of the control panel 101 is implemented to meet fire code standards despite any connections of the control panel 101 to the other safety/automation systems (e.g., 102, 104) and despite any functionality provided by the control panel 101 to the other safety/automation systems (e.g., 102, 104). The control panel 101 may also include further aspects to meet the standards requirements of the other safety/automation systems (e.g., 102, 104). For example, when the other safety/automation systems 102 include an intrusion/security system 102, the control panel 101 may be configured to meet residential or commercial burglary security standards.

In some aspects, for example, fire approvals require that adding any functionality related to the other safety/automation systems (e.g., 102, 104) to the control panel 101 does not hinder proper and regulatory-compliant operation of the fire protection system 106. Accordingly, for example, when the other safety/automation systems include an intrusion/security system 102, security devices of the intrusion/security system 102 are not placed on a same bus as fire protection devices of the fire protection system 106. Similarly, when the other safety/automation systems include an access control system 104, access control devices of the access control system 104 are not placed on a same bus as fire protection devices of the fire protection system 106. Instead, some present aspects meet the standard/safety requirements of the fire protection system 106 by implementing hardware and supporting software in the control panel 101 to isolate and separate the fire protection system 106 from the other safety/automation systems (e.g., 102, 104).

For example, in some aspects, the control panel 101 may include a first bus 308 for input/output communication with, and/or for providing power to, one or more components of the fire protection system 106, and one or more additional buses (e.g., second bus 310, third bus 311) for input/output communication with, and/or for providing power to, one or more components of the other safety/automation systems (e.g., intrusion/security system 102, access control system 104). In these aspects, since non-fire-related devices are not added on the circuit that is serving the fire protection equipment of the fire protection system 106, the non-fire-related devices do not interfere with the fire protection devices of the fire protection system 106, and vice versa.

For example, due to the separation of the first bus 308 and the second bus 310, a bus issue in the intrusion/security system 102 (such as a surge, fault, etc. in the intrusion/security system 102) does not affect the operation of the fire protection system 106. Similarly, due to the separation of the first bus 308 and the third bus 311, a bus issue in the access control system 104 (such as a surge, fault, etc. in the access control system 104) does not affect the operation of the fire protection system 106.

Further, the first bus 308 may have a configuration (e.g., wire gauge, etc.) that meets fire codes/standards and is different than a respective configuration of the second bus 310 and/or the third bus 311 (e.g., wire gauge, etc. of the second bus 310 and/or the third bus 311). Further, in some aspects, the second bus 310 may have a configuration (e.g., wire gauge, etc.) that meets the codes/standards of the intrusion/security system 102, and the third bus 311 may have a configuration (e.g., wire gauge, etc.) that meets the codes/standards of the access control system 104.

In some further aspects, the one or more processors 302, individually, as a subgroup, or in configuration, may implement different signaling/power control functionality on the first bus 308, on the second bus 310, and on the third bus 311, according to respective demands/requirements of the fire protection system 106, the intrusion/security system 102, and the access control system 104. For example, the one or more processors 302, individually, as a subgroup, or in combination, may execute different software to separately control the amount of power provided to the fire protection system 106 over the first bus 308, to the intrusion/security system 102 over the second bus 310, and to the access control system 232 over the third bus 311. For example, the one or more processors 302, individually, as a subgroup, or in combination, may accomplish this by executing different software to separately control a first current measurement/control circuitry 304 on the first bus 308, a second current measurement/control circuitry 306 on the second bus 310, and a third control circuitry 307 on the third bus 311, as described in further detail below.

By separating the buses that serve the fire protection system 106 and the other safety/automation systems (e.g., 102, 104), the control panel 101 implements the functionality of the fire protection system 106 and the other safety/automation systems (e.g., 102, 104) in a single box while still meeting the requirements of the fire protection system 106, without overly complicating the fire protection system 106 and the other safety/automation systems (e.g., 102, 104).

In some aspects, the control panel 101 implements separate current control functionality for the fire protection system 106 and one or more of the other safety/automation systems (e.g., 102) such that current feedback from one system is not fed to the other system. For example, in some aspects, the control panel 101 includes the first current measurement/control circuitry 304 that is controlled by the one or more processors 302, individually, as a subgroup, or in combination, to implement current control on the first bus 308 that feeds the fire protection system 106, and the control panel 101 includes the second current measurement/control circuitry 306 that is separately controlled by the one or more processors 302, individually, as a subgroup, or in combination, to implement current control on the second bus 310 that feeds the intrusion/security system 102. Further, in some aspects, the control panel 101 includes the third control circuitry 307 that is separately controlled by the one or more processors 302, individually, as a subgroup, or in combination, to control the third bus 311 that feeds the access control system 104.

For example, in some non-limiting aspects, for a 12V voltage supply level provided by the printed circuit board (PCB) at the control panel 101, the one or more processors 302, individually, as a subgroup, or in combination, may control the first current measurement/control circuitry 304 to set a 4 Amps current limit on the current drawn over the first bus 308 by the components of the fire protection system 106, while the one or more processors 302, individually, as a subgroup, or in combination, may control the second current measurement/control circuitry 306 to set a 2 Amps current limit on the current drawn over the second bus 310 by the components of the intrusion/security system 102. Additionally, the one or more processors 302, individually, as a subgroup, or in combination, may control the third control circuitry 307 to set a 1.75 Amps current limit on the current drawn over the third bus 311 by the components of the access control system 104. In some aspects, for example, the one or more processors 302, individually, as a subgroup, or in combination, may deduce an estimated amount of power drawn over the third bus 311 by subtracting the amount of power drawn over the first bus 308 and the second bus 310 (as measured by 304 and 306) from the total power drawn from the battery circuit 328, as described in further detail below.

In some aspects, for example, the fire protection system 106 may include a fire panel 312 and/or one or more loop interface modules 316. The fire panel 312 and the loop interface modules 316 are powered by the control panel 101 via the first bus 308. Further, the fire panel 312 and the loop interface modules 316 communicate with the one or more processors 302 in the control panel 101 via the first bus 308. Each loop interface module 316 may terminate a loop to which one or more fire protection devices are connected (e.g., in a daisy chain configuration). Each loop terminated by a loop interface module 316 may be connected to a number of fire protection devices (e.g., up to 120 or 256 fire protection devices), and the loop provides signal communication and power to the fire protection devices connected thereon.

The fire protection devices on a loop may include one or more initiating devices and/or one or more notification devices. The initiating devices may include fire detection devices such as smoke detectors, heat detectors, carbon monoxide (CO) detectors, etc. The notification devices may include audible and/or visual notification devices such as strobes, sirens, visual signs, etc.

In some non-limiting example aspects, one or more of the fire protection devices connected to a loop that is terminated by a loop interface module 316 may be addressable. In these aspects, the first bus 308 may include a pair of wires for selectively establishing signal/data communication with the addressable fire protection devices. In this case, the loop interface module 316 allows for addressing a particular fire protection device, for example, via the fire panel 312 and/or via the control panel 101. For example, the loop interface module 316 may allow for an addressable notification device to be selectively activated via the fire panel 312 and/or via the control panel 101. Also, for example, the loop interface module 316 may allow for an addressable initiating device to be selectively configured (e.g., for fire detection sensitivity, sleep time, etc.) via the fire panel 312 and/or via the control panel 101. Further, for example, the loop interface module 316 may allow for an addressable notification device that generated a signal to be individually identified by the fire panel 312 and/or the control panel 101.

In some non-limiting aspects, one or more of the other safety/automation systems controlled by the control panel 101 may also include respective panels. For example, the intrusion/security system 102 may include an intrusion/security panel 314. Similarly, the access control system 104 may include an access control panel 315. Similarly, a building controls system (not shown) may include a building controls panel (not shown).

In some aspects, the functionality of the fire panel 312 may be implemented by the control panel 101. For example, the control panel 101 may implement a virtual fire panel for controlling the fire protection system 106. In some aspects, the functionality of the intrusion/security panel 314 may be implemented by the control panel 101. For example, the control panel 101 may implement a virtual intrusion panel for controlling the intrusion/security system 102. Similarly, the control panel 101 may implement a virtual access control panel for controlling the access control system 104. Similarly, the control panel 101 may implement a virtual building controls panel for controlling a building controls system (not shown).

The intrusion/security system 102 may also include one or more repeater modules 318 and/or one or more expander modules 320. The intrusion/security panel 314, the repeater modules 318, and the expander modules 320 are powered by the control panel 101 via the second bus 310. Further, the intrusion/security panel 314, the repeater modules 318, and the expander modules 320 communicate with the one or more processors 302 in the control panel 101 via the second bus 310. Each expander module 320 is configured to expand the intrusion/security system 102 by providing additional input/output connections for adding one or more sensors/devices to the intrusion/security system 102. Each repeater module 318 is configured to boost the signal strength on the second bus 310 in order to increase the range of coverage of the intrusion/security system 102, e.g., in order to increase the area covered by the sensors/devices in the intrusion/security system 102.

In some cases, for example, one or more sensors/devices (e.g., a magnetic door/window sensor, a passive infrared (PIR) motion detector, etc., in the intrusion/security system 102) may be directly connected to the control panel 101, and the one or more processors 302, individually, as a subgroup, or in combination, may read the status of the sensors/devices and/or otherwise communicate with the sensors/devices over such direct connections to the control panel 101. However, the control panel 101 may have a limited number of such input/output connections. Accordingly, an expander module 320 (also referred to as a zone expander) may be used to increase the number of input/output connections for connecting additional sensors/device in the intrusion/security system 102. In one non-limiting aspect, for example, an expander module 320 may include a terminal block providing a number of additional inputs/outputs or “zones” (e.g., 8 additional zones), where a zone refers to a sensor/device. The expander module 320 may multiplex the signals of these additional zones for signal communication with the one or more processors 302 over the second bus 310.

In an aspect, each time a sensor/device is connected to one of the terminal inputs of the expander module 320, the expander module 320 indicates, via an addressing system, the addition of the sensor/device on the expander module 320 to the one or more processors 302 over the bus 310. For example, the expander module 320 notifies the one or more processors 302, over the second bus 310, that input 1 of zone expander 1 has been detected. The one or more processors 302, individually, as a subgroup, or in combination, may then update a mapping to indicate a zone detected in an extended/larger actual physical area.

In some aspects, the first bus 308 may include two wires for providing power and two wires for establishing differential signal communication, for example, according to the RS-485 protocol that allows for driving data over long distance wiring.

In some aspects, the access control system 104 may include an access control reader 319 that is connected to both the power and the data wire of the third bus 311, so that the access control reader 319 is powered over the third bus 311 and also communicates data with the control panel 101 over the third bus 311. In some aspects, the access control system 104 may include an access control lock 321 that is connected only to the power wire of the third bus 311, so that the access control lock 321 is powered over the third bus 311 but does not communicate data over the third bus 311.

Some further aspects include the following:
1. A control panel of a premises environment platform associated with a premises, the control panel comprising:
a processor;
a first bus communicatively coupling the processor with one or more components of a fire protection system of the premises; and
a second bus communicatively coupling the processor with one or more components of a safety/automation system of the premises, wherein the second bus is different than the first bus, wherein the safety/automation system is different than the fire protection system.
2. The control panel of clause 1, wherein the first bus comprises:
a first pair of wires configured to power the one or more components of the fire protection system; and
a second pair of wires configured to provide differential data communication between the processor and the one or more components of the fire protection system.
3. The control panel of clause 1, wherein the second bus comprises:
a first pair of wires configured to power the one or more components of the safety/automation system; and
a second pair of wires configured to provide differential data communication between the processor and the one or more components of the safety/automation system.
4. The control panel of clause 1, further comprising:
a first current measurement/control circuitry configured to control a first current provided over the first bus to power the one or more components of the fire protection system; and
a second current measurement/control circuitry configured to control a second current provided over the second bus to power the one or more components of the safety/automation system.
5. The control panel of clause 4, wherein the processor is configured to control the first current measurement/control circuitry and the second current measurement/control circuitry.
6. The control panel of clause 4, wherein the processor is configured to set a first current limit on the first bus by controlling the first current measurement/control circuitry, wherein the processor is configured to set a second current limit on the second bus by controlling the second current measurement/control circuitry.
7. The control panel of clause 1, wherein the one or more components of the fire protection system comprise a fire panel.
8. The control panel of clause 1, wherein the one or more components of the fire protection system comprise one or more loop interface modules.
9. The control panel of clause 8, wherein each one or the one or more loop interface modules is configured to terminate at least one loop to which one or more fire protection devices are connected.
10. The control panel of clause 9, wherein the one or more fire protection devices comprises one or more initiating or notification devices.
11. The control panel of clause 1, wherein the one or more components of the safety/automation system comprise a safety/automation panel.
12. The control panel of clause 11, wherein the safety/automation system comprises an intrusion system, and the safety/automation panel comprises an intrusion panel.
13. The control panel of clause 1, wherein the one or more components of the safety/automation system comprise one or more repeater modules.
14. The control panel of clause 1, wherein the one or more components of the safety/automation system comprise one or more expander modules.
15. The control panel of clause 1, wherein the premises environment platform comprises a cloud platform.
16. The control panel of clause 1, wherein both the fire protection system of the premises and the safety/automation system of the premises are controllable via the control panel of the premises environment platform.
17. An apparatus comprising:
a memory storing instructions; and
a processor communicatively coupled with the memory and configured to execute the instructions to implement the control panel of any one or any combination of clauses 1 to 16.

In some present aspects, the control panel 101 may execute a battery management algorithm 330 that is configured to ensure that there is sufficient battery backup for each one of the systems controlled by the control panel 101. For example, the battery management algorithm 330 may be configured to ensure that there is battery backup for the fire protection system 106 for a sufficient duration (e.g., a certain number of hours such as 24 hours) specified by a fire code/standard. The fire code/standard may be different for different geographical areas, e.g., North America, European Union, etc., in which case the algorithm may be configured to meet different battery backup durations specified by different fire codes/standards. The battery management algorithm 330 may further be configured to ensure that there is battery backup for the other safety/automation systems (e.g., 102, 104) for a sufficient duration specified by a code/standard relevant to the safety/automation system 102 (e.g., 24 hours of battery backup for the intrusion/security system 102 of a residential building, 72 hours of battery backup for the intrusion/security system 102 of a commercial building such as a bank, 4 hours of battery backup for the access control system 104, etc.).

In some non-limiting example aspects, in providing standby power, the battery management algorithm 330 may be configured to give priority to some systems over some other systems. The priority may be determined based on regulatory requirements of each system, and optionally further based on pre-configured/user-defined configuration information. For example, during standby operation, the battery management algorithm 330 may be configured to disconnect one or more of the systems controlled by the control panel 101 in order to ensure sufficient standby time and/or prolonged standby operation for some other ones of the systems controlled by the control panel 101.

In some aspects, the battery management algorithm 330 may use stored/user-defined/pre-configured standby priority configuration information to determine how to give priority to some systems over some other systems. The standby priority configuration information may indicate the order in which to disconnect the systems during standby operation. The standby priority configuration information may be user-defined by a user of the control panel 101 (either locally or remotely via a wired or wireless connection to the control panel 101), may be pre-configured during installation of the control panel 101, etc.

In some non-limiting aspects, for example, the standby requirement of the intrusion/security system 102 may be longer than the standby requirement of the fire protection system 106 and the access control system 104. In this case, the battery management algorithm 330 may be configured to give priority to the intrusion/security system 102 over the fire protection system 106 and the access control system 104. For example, the intrusion/security system 102 of a bank may require 72 hours of standby battery, which is more than the 24 hour standby requirement of the fire protection system 106 and the 4 hour standby requirement of the access control system 104. In this case, after 4 hours of standby operation, the battery management algorithm 330 may disconnect the access control system 104 whose 4 hour standby requirement is met, while still keeping the intrusion/security system 102 and the fire protection system 106 connected, and after 24 hours of standby operation, the battery management algorithm 330 may disconnect the fire protection system 106 whose 24 hour standby requirement is met, while still keeping the intrusion/security system 102 connected.

In some alternative example non-limiting aspects, the access control system may have a 4 hour standby requirement, while the fire protection system 106 and the intrusion/security system 102 each have a 24 hour standby requirement (e.g., for a residential building). In this case, the battery management algorithm 330 may be configured to give priority to the fire protection system 106 over the intrusion/security system 102 and the access control system 104, for example, by disconnecting one or both of the intrusion/security system 102 and the access control system 104 to prolong battery backup duration for the fire protection system 106. For example, after 4 hours of standby operation, the battery management algorithm 330 may disconnect the access control system 104 whose 4 hour standby requirement is met, while still keeping the intrusion/security system 102 and the fire protection system 106 connected, and after 24 hours of standby operation, the battery management algorithm 330 may disconnect the intrusion/security system 102 whose 24 hour standby requirement is met, while still keeping the fire protection system 106 connected.

Alternatively, the priority of the intrusion/security system 102 and the fire protection system 106 which both have a 24 hour standby requirement may be reversed, and after 24 hours of standby operation, the battery management algorithm 330 may disconnect the fire protection system 106 whose 24 hour standby requirement is met, while still keeping the intrusion/security system 102 connected.

In yet further alternative aspects, after the 4 hours of standby requirement of the access control system 104 is met, if the power consumed by the access control system 104 is less than a threshold (e.g., less than 100 milliamps), the battery management algorithm 330 may still keep the access control system 104 connected.

In some aspects, the control panel 101 may also disable one or more functionalities to preserve power. For example, the control panel 101 may disable one or more cellular radios in the control panel 101 and/or in the systems controlled by the control panel 101 to preserve battery.

In some aspects, the control panel 101 includes one or more batteries, such as, but not limited to, two batteries including a first battery 324 and a second battery 326. In these aspects, the battery management algorithm 330 in the control panel 101, when executed by the one or more processors 302, individually, as a subgroup, or in combination, is configured to control a battery circuit 328 in the control panel 101 to charge/discharge the first battery 324 and/or the second battery 326 at same or different times, at same or different charge/discharge rates, to same or different charge levels, etc. In some aspects, the control panel 101 may also be connected to one or more low power systems 335 and/or one or more auxiliary devices/systems 333, and the battery circuit 328 may be configured to supply power to these systems.

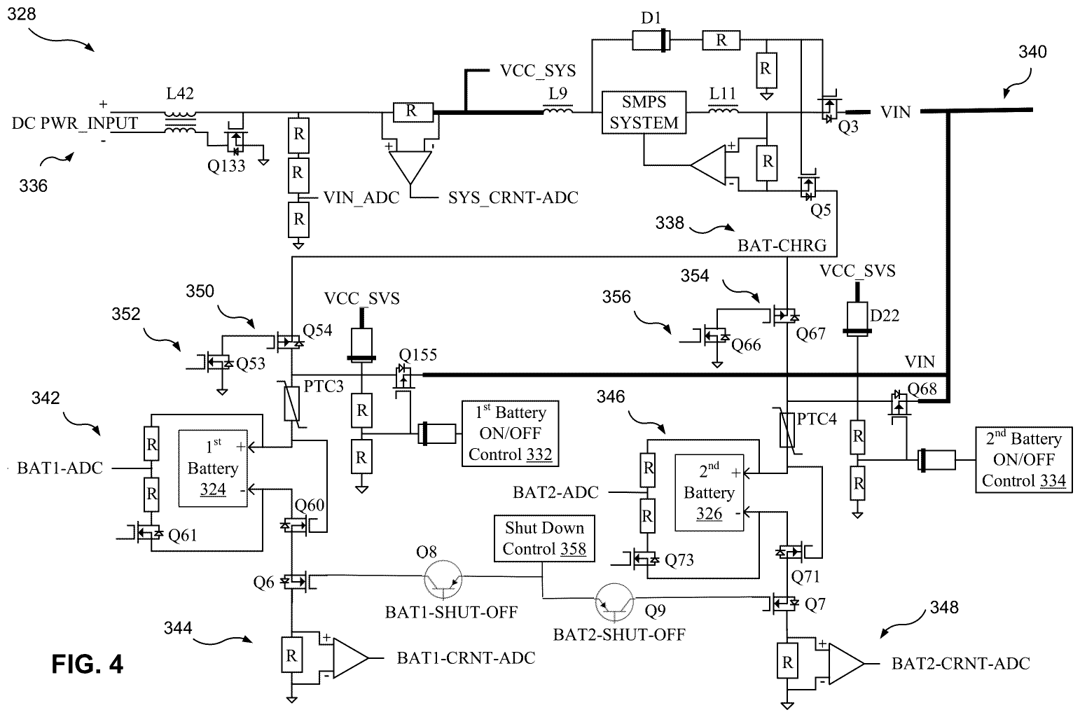

Referring to FIG. 4, an example non-limiting aspect of the battery circuit 328 is configured to supply power to an output power line VIN 340 in the control panel 101. Under normal operation, the battery circuit 328 may supply power to the output power line VIN 340 by drawing power from a DC input power line 336. However, in case of a power failure on the DC input power line 336, the battery circuit 328 may supply power to the output power line VIN 340 by drawing power from the first battery 324 and/or from the second battery 326. The connection of the first battery 324 to the DC input power line 336 is controllable by a first battery ON/OFF control component 332 via a switch Q155, which may be, but is not limited to, a metal-oxide-semiconductor field-effect transistor (MOSFET) switch. Similarly, and independently of the first battery 324, the connection of the second battery 326 to the DC input power line 336 is controllable by a second battery ON/OFF control component 334 via a switch Q68, which may be, but is not limited to, a MOSFET switch.

The battery circuit 328 may also use the DC input power line 336 to charge the first battery 324 and/or the second battery 326. For example, the battery circuit 328 may use the DC input power line 336 to supply a battery charging current to a battery charging line 338 to charge the first battery 324 and/or the second battery 326. The connection of the battery charging line 338 to the first battery 324 is controllable via a switch Q54, which may be, but is not limited to, a MOSFET switch. For example, in an aspect, a gate 350 of the switch Q54 is controllable by a switch Q53, and a gate 352 of the switch Q53 is controllable by the one or more processors 302, individually, as a subgroup, or in combination. For example, in an aspect, a gate 350 of the switch Q54 is controllable by a switch Q53, and a gate 352 of the switch Q53 is controllable by the one or more processors 302. Similarly, and independently of the first battery 324, the connection of the battery charging line 338 to the second battery 326 is controllable via a switch Q67, which may be, but is not limited to, a MOSFET switch. For example, in an aspect, a gate 354 of the switch Q67 is controllable by a switch Q66, and a gate 356 of the switch Q66 is controllable by the one or more processors 302, individually, as a subgroup, or in combination. For example, in an aspect, a gate 354 of the switch Q67 is controllable by a switch Q66, and a gate 356 of the switch Q66 is controllable by the one or more processors 302, individually, as a subgroup, or in combination.

The voltage and current of the first battery 324 are measurable via a first voltage measurement circuit 342 and a first current measurement circuit 344, respectively. Similarly, and independently of the first battery 324, the voltage and current of the second battery 326 are measurable via a second voltage measurement circuit 346 and a second current measurement circuit 348, respectively. It is noted that when the first battery 324 and the second battery 326 are connected in parallel to one another, their voltages are the same and therefore either one of the first voltage measurement circuit 342 or the second voltage measurement circuit 346 may be used to measure the voltage of the first battery 324 and the second battery 326. The first battery 324 and the second battery 326 are connected in parallel to one another when they are both connected to the battery charging line 338 and are being charged simultaneously. The first battery 324 and the second battery 326 are also connected in parallel to one another when they are both connected to the output power line VIN 340 and are being discharged simultaneously.

In some aspects, if needed, each one or both of the first battery 324 and the second battery 326 may be entirely disconnected from the battery circuit 328. For example, in some aspects, a shutdown control hardware circuit 358 is configured in the battery circuit 328 to monitor the output power line VIN 340 while the system is on battery backup, and to disconnect both the first battery 324 and the second battery 326 simultaneously once the first battery 324 and the second battery 326 reach a critical shut-down threshold. Specifically, for example, in one non-limiting aspect, the shutdown control hardware circuit 358 may do so by simultaneously controlling the emitter pin/connection of a switch Q8 and a switch Q9 (each of which may be, but is not limited to, a transistor switch), which in turn control a switch Q6 and a switch Q7 (each of which may be, but is not limited to, a MOSFET switch), which in turn disconnect the first battery 324 and the second battery 326, respectively.

Further, in some aspects, the first battery 324 and the second battery 326 may be individually and separately disconnected under software control. This may be performed, for example, in order to individually charge/discharge the first battery 324 and/or to replace the first battery 324 and/or to separately test the first battery 324, for example, using a standalone/portable battery test unit. Specifically, for example, in order to disconnect the first battery 324 from the battery circuit 328, the switch Q6 may be controlled by the switch Q8, which is controlled by a “Battery 1 Shut Off” signal supplied by the one or more processors 302, individually, as a subgroup, or in combination, to a base pin/connection of the switch Q8.

Similarly, and independently of the first battery 324, the second battery 326 may be entirely disconnected from the battery circuit 328. This may be performed, for example, in order to individually charge/discharge the second battery 326 and/or to replace the second battery 326 and/or to separately test the second battery 326, for example, using a standalone/portable battery test unit. Specifically, for example, in order to disconnect the second battery 326 from the battery circuit 328, the switch Q7 may be controlled by the switch Q9, which is controlled by a “Battery 2 Shut Off” signal supplied by the one or more processors 302, individually, as a subgroup, or in combination, to a base pin/connection of the switch Q9.

In some aspects, the battery circuit 328 further includes switches Q60 and Q71 (each of which may be, but is not limited to, a MOSFET switch), which are used for reverse battery protection of the first battery 324 and the second battery 326, respectively.

In some aspects, the difference in the charge level of the first battery 324 and the second battery 326 may be beyond a threshold. The charge level of the first battery 324 and the second battery 326 may be sensed by the first voltage measurement circuit 342 and the second current measurement circuit 348, respectively, and reported to the one or more processors 302. In some cases, for example, the charge level of the first battery 324 and the second battery 326 may be different immediately after an installer replaces one or both of the first battery 324 and/or the second battery 326. Alternatively, the charge level of the first battery 324 and the second battery 326 may be different in case the first battery 324 and/or the second battery 326 starts to fail (e.g., in case of losing a shorted cell within the first battery 324 and/or the second battery 326).

In some aspects, if the charge level of the first battery 324 and the second battery 326 are not balanced and they are both used in parallel to supply standby power to the control panel 101, the battery with the higher charge level will cause back feed current into the battery with the lower charge, which may cause damage to the battery circuit 328. For example, the current of the first battery 324 and/or the second battery 326 may exceed 40 Amps, which may cause damage to one or more of the switches in the battery circuit 328, e.g., Q6 and/or Q7, each of which may be, but is not limited to, a MOSFET switch. Such an increase in the current of the first battery 324 and/or the second battery 326 may be sensed by the first current measurement circuit 344 and/or the second current measurement circuit 348, respectively, and reported to the one or more processors 302.

In some aspects, if the difference in the charge level of the first battery 324 and the second battery 326 is beyond a threshold, the one or more processors 302 in the control panel 101, individually, as a subgroup, or in combination, may execute the battery management algorithm 330 to control one or more switches in the battery circuit 328 to isolate the first battery 324 and the second battery 326 from each other until the charge level of the first battery 324 and the second battery 326 is equalized (e.g., is brought within 100 millivolts), so that the first battery 324 and the second battery 326 may be safely joined together to supply power to the control panel 101 in standby mode.

For example, in one non-limiting aspect, if the first battery 324 is fully charged (or at least has a charge level above a threshold) while the second battery 326 is not fully charged (or has a charge level below a threshold), the one or more processors 302, individually, as a subgroup, or in combination, may control the battery circuit 328 to isolate the second battery 326 from the first battery 324 and to connect the second battery 326 to the battery charging line 338 until the second battery 326 is also fully charged (or has a charge level above a threshold). For example, the one or more processors 302, individually, as a subgroup, or in combination, may ensure that switch Q68 is disconnected (or may disconnect switch Q68) to isolate the second battery 326 from the output power line VIN 340 and from the first battery 324, and may ensure that switch Q67 is connected (or may connect switch Q67) to connect the second battery 326 to the battery charging line 338 and supply battery charging current to the second battery 326.

In some aspects, when a mains power supply of the control panel 101 is lost, the one or more processors 302 in the control panel 101, individually, as a subgroup, or in combination, may execute the battery management algorithm 330 to disconnect/shut down one or more output connections on the control panel 101 to preserve the battery charge and to increase the standby time. For example, in one non-limiting aspect, the control panel 101 may control both the fire protection system 106 of a premises and an access control system of the premises. The access control system may only require four hours of backup standby time. If the mains power supply is lost and the control panel 101 enters a standby mode using battery power, after four hours of standby operation, the control panel 101 may disconnect/shut down the access control system in order to ensure the longer standby time requirement of the fire protection system 106, which may be, for example, 24 hours.

In one non-limiting example aspect, a specific type of access control device may not use a lot of energy in standby mode. In this case, the battery management algorithm 330 may be configurable/customizable to allow the low power device to stay connected and powered when the rest of the access control system is shut down after four hours of standby time.

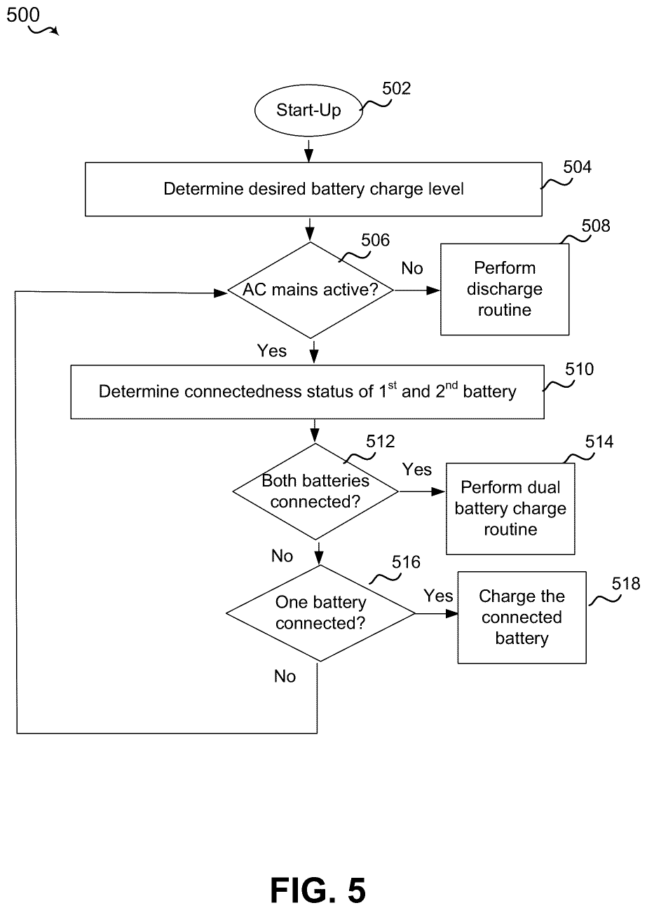

Referring to FIG. 5, in one non-limiting aspect, for example, the one or more processors 302, individually, as a subgroup, or in combination, may be configured to or may comprise means for starting a start-up routine 500 at 502, e.g., by setting port outputs to proper levels and clearing one or more flags. At 504 the one or more processors 302, individually, as a subgroup, or in combination, may be configured to or may comprise means for determining (e.g., based on the value of a flag set by an installer) the desired battery level charge of the first battery 324 and the second battery 326. The desired battery level charge may depend on backup requirements of the safety/automation systems that are controlled by the control panel 101. In some aspects, for example, the desired battery level charge may be 700 milliamps or 1.4 amps.

At 506 the one or more processors 302, individually, as a subgroup, or in combination, may be configured to or may comprise means for determining whether the AC mains is active. If not, at 508 the one or more processors 302, individually, as a subgroup, or in combination, perform the battery discharge routine (explained in detail below). Otherwise, at 510 the one or more processors 302, individually, as a subgroup, or in combination, may be configured to or may comprise means for determining the connectedness status of the first battery 324 and the second battery 326, e.g., determining whether the first battery 324 and the second battery 326 are connected to the corresponding terminals in the control panel 101. The one or more processors 302, individually, as a subgroup, or in combination, may do so based on voltage measurements across these terminals. For example, if the voltage across the battery terminals of the first battery 324 is less than a thresholds (e.g., 9 volts, as measured by the first voltage measurement circuit 342), the one or more processors 302, individually, as a subgroup, or in combination, determine that the first battery 324 is missing. Similarly, if the voltage across the battery terminals of the second battery 326 is less than a thresholds (e.g., 9 volts, as measured by the second voltage measurement circuit 346), the one or more processors 302, individually, as a subgroup, or in combination, determine that the second battery 326 is missing.

At 512, the one or more processors 302, individually, as a subgroup, or in combination, may be configured to or may comprise means for determining whether both the first battery 324 and the second battery 326 are connected. If yes, at 514 the one or more processors 302, individually, as a subgroup, or in combination, may be configured to or may comprise means for performing a dual battery charge routine (described in detail below). If not, at 516 the one or more processors 302, individually, as a subgroup, or in combination, may be configured to or may comprise means for determining if one of the batteries is connected. If yes, at 518 the one or more processors 302, individually, as a subgroup, or in combination, may be configured to or may comprise means for controlling one or more switches in the battery circuit 328 to charge the connected battery, e.g., either the first battery 324 or the second battery 326. Otherwise, the one or more processors 302, individually, as a subgroup, or in combination, may be configured to or may comprise means for looping back to 506.

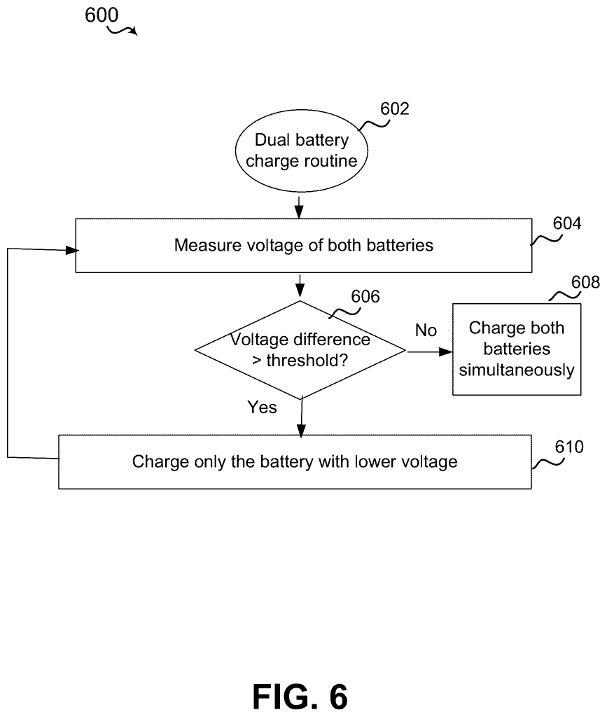

Referring to FIG. 6, in one non-limiting example aspect, at 602 the one or more processors 302, individually, as a subgroup, or in combination, may be configured to or may comprise means for starting the dual battery charge routine 600. At 604 the one or more processors 302, individually, as a subgroup, or in combination, may be configured to or may comprise means for reading the voltage measurements of the first battery 324 and the second battery 326. At 606 the one or more processors 302, individually, as a subgroup, or in combination, may be configured to or may comprise means for determining whether the difference between the voltage of the first battery 324 and the second battery 326 is greater than a threshold, e.g., greater than 0.1 volts. If not, at 608 the one or more processors 302, individually, as a subgroup, or in combination, may be configured to or may comprise means for controlling one or more switches in the battery circuit 328 to charge both the first battery 324 and the second battery 326 simultaneously.

If the difference between the voltage of the first battery 324 and the second battery 326 is greater than the threshold, e.g., greater than 0.1 volts, at 610 the one or more processors 302, individually, as a subgroup, or in combination, may be configured to or may comprise means for controlling one or more switches in the battery circuit 328 to charge only the battery with the lower voltage and loops back to 604.

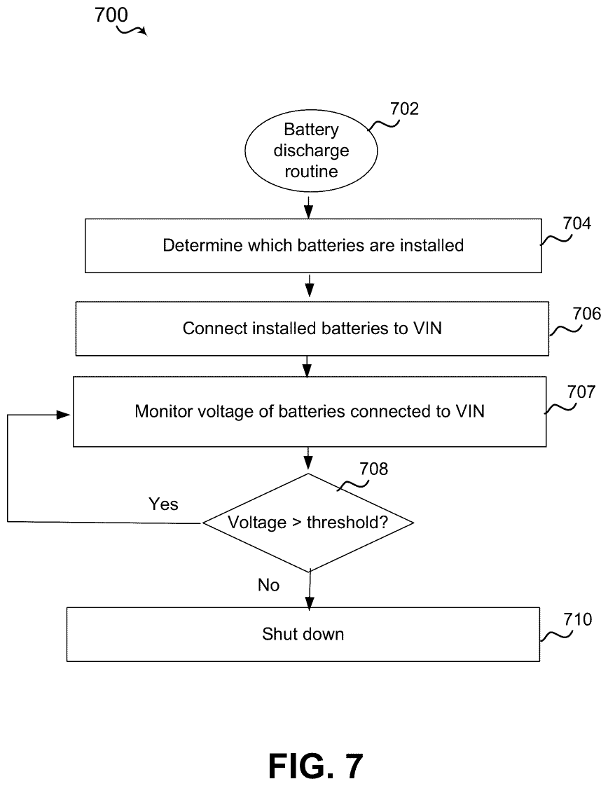

Referring to FIG. 7, in one non-limiting example aspect, at 702 the one or more processors 302, individually, as a subgroup, or in combination, may be configured to or may comprise means for starting the battery discharge routine 700. At 704 the one or more processors 302, individually, as a subgroup, or in combination, may be configured to or may comprise means for determining which batteries are installed. The one or more processors 302, individually, as a subgroup, or in combination, may do so based on the voltage measurement readings at the battery terminals in the battery circuit 328 as described above. At 706 the one or more processors 302, individually, as a subgroup, or in combination, may be configured to or may comprise means for controlling one or more switches in the battery circuit 328 to connect the installed batteries to the output power line VIN 340. For example, if the reading of the first voltage measurement circuit 342 indicates that the first battery 324 is installed, the one or more processors 302, individually, as a subgroup, or in combination, may be configured to or may comprise means for causing switches Q155 and Q6 to close or to stay closed to connect the first battery 324 to the output power line VIN 340. Similarly, if the reading of the second voltage measurement circuit 346 indicates that the second battery 326 is installed, the one or more processors 302, individually, as a subgroup, or in combination, may be configured to or may comprise means for causing switches Q68 and Q7 to close or to stay closed to connect the second battery 326 to the output power line VIN 340. It is noted that if both the first battery 324 and the second battery 326 are installed, they will both be connected to the output power line VIN 340 in parallel to one another.

At 707 the one or more processors 302, individually, as a subgroup, or in combination, may be configured to or may comprise means for monitoring the voltages of the batteries that are connected to the output power line VIN 340, e.g., based on the voltage measurements of a respective voltage measurement circuit. At 708 the one or more processors 302, individually, as a subgroup, or in combination, may be configured to or may comprise means for determining if the voltage of a connected battery is below a software shutdown threshold value. If not, the one or more processors 302, individually, as a subgroup, or in combination, may be configured to or may comprise means for looping back to 707. Otherwise, the one or more processors 302, individually, as a subgroup, or in combination, may be configured to or may comprise means for shutting down the control panel 101 at 710.

Some present aspects may implement maximum current control at the screwheads of the control panel 101, e.g., at the connections of the control panel 101 that supply power to a device/system. The maximum allowable current may be specified by a standards body such as the Underwriter Laboratories (UL), in order to implement a limited energy circuit to prevent a fire event which may happen due to overheating of electrical connections/wires with high current. In one non-limiting aspect, for example, the maximum allowable current at each screwhead/connection to the control panel 101 may be, for example, 8 Amps.

Referring back to FIG. 3, in one non-limiting aspect, for example, the control panel 101 may include current measurement/control circuitry for one or more screwheads/connections to one or more connected systems. In some aspects, the current measurement/control circuitry may include a current measurement circuit and/or a current control circuit. For example, the control panel 101 may include the first current measurement/control circuitry 304 for the fire protection system 106 and the second current measurement/control circuitry 306 for the intrusion/security system 102. In this case, if a current measurement/control circuitry of a system indicates that the current supplied through a control panel screwhead/connection to that system has exceeded a maximum allowable current threshold (e.g., 6 Amps), the one or more processors 302, individually, as a subgroup, or in combination, may control the current control/measurement circuitry of that screwhead/connection to disconnect that screwhead/connection (e.g., by disconnecting a switch in a respective current measurement/control circuitry) and/or to drop the voltage on that screwhead/connection to reduce the current to an allowable level. Alternatively or additionally, the current measurement/control circuitry of a screwhead/connection may implement a local analog current control mechanism (e.g., an op-amp feedback loop) to disconnect the screwhead/connection or reduce the amount of current if the current exceeds a threshold.

In some aspects, the control panel 101 may further include the third control circuitry 307 for the access control system 104. In some aspects, the third control circuitry 307 may also include current measurement functionality similar to the first current measurement/control circuitry 304 and the second current measurement/control circuitry 306. However, in some other aspects, the third control circuitry 307 may not include current measurement functionality. In this case, the one or more processors 302, individually, as a subgroup, or in combination, may still deduce an estimated amount of current drawn through the screwheads/connections of the access control system 104 by subtracting the current drawn by the current-monitored connections (e.g., the connections having a current measurement/control circuitry thereon, e.g., 304, 306) from the total current drawn from the battery circuit 328. The one or more processors 302, individually, as a subgroup, or in combination, may then disconnect the screwheads/connections of the access control system 104 if the deduced amount of current drawn by the screwheads/connections of the access control system 104 exceeds a maximum allowable current threshold (e.g., exceeds 6 Amps).

In some alternative or additional aspects, the control panel 101 may also include one or more screwheads/connections to one or more auxiliary devices/systems 333 with no current control/measurement circuitry at these screwheads/connections. These screwheads/connections may be allocated, for example, for one or more fire protection auxiliary outputs (e.g., a siren), one or more auxiliary outputs for an intrusion/security system (e.g., a camera), one or more optional devices installed by a customer (e.g., a doorbell camera), etc. The one or more processors 302, individually, as a subgroup, or in combination, may still deduce the amount of current drawn through the screwheads/connections of the auxiliary devices/systems 333 by subtracting the current drawn by the current-monitored connections (e.g., the connections having a current measurement/control circuitry thereon) from the total current drawn from the battery circuit 328. The one or more processors 302, individually, as a subgroup, or in combination, may then disconnect the screwheads/connections of the auxiliary devices/systems 333 if the deduced amount of current drawn by the screwheads/connections of the auxiliary devices/systems 333 exceeds a maximum allowable current threshold (e.g., exceeds 6 Amps).

In some alternative or additional aspects, the control panel 101 may also include one or more screwheads/connections to one or more low power systems 335 with no current control/measurement circuitry at these screwheads/connections. In one non-limiting example aspect, the low power systems 335 may include an access control system with occasional low power consumption (e.g., low current consumption only when an entrance/exit of a premises is accessed). In this case, the one or more processors 302, individually, as a subgroup, or in combination, may leave these connections ON and may not perform any current control regarding these screwheads/connections. These screwheads/connections may also include a fuse to get automatically/locally disconnected if needed.

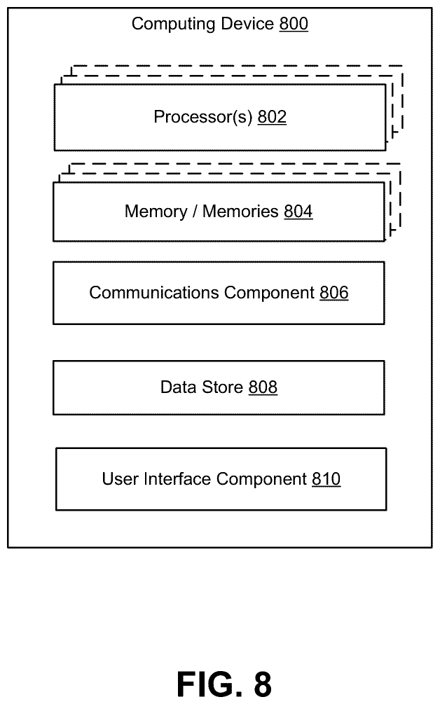

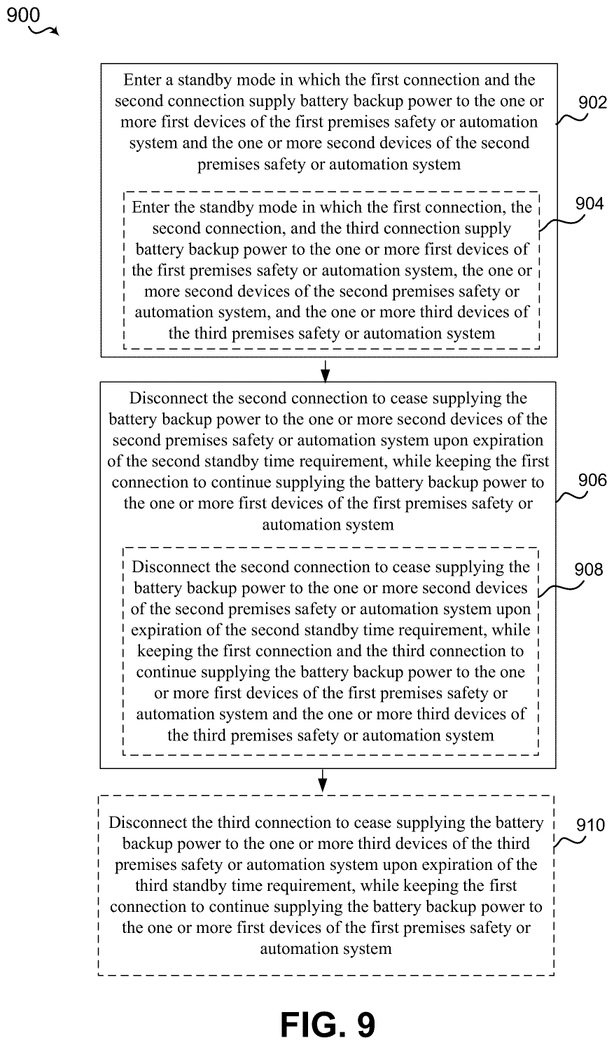

Referring to FIG. 8, an example block diagram provides details of computing components in a computing device 800 that may implement all or a portion of the premises environment platform 100, the control panel 101, the intrusion/security system 102, the fire protection system 106, the access control system 104, the building controls system 108, the cloud system 110, the fire panel 312, the intrusion/security panel 314, the loop interface module(s) 316, the repeater module(s) 318, the expander module(s) 320, the access control panel 315, the access control reader 319, the access control lock 321, the one or more processors 302, the battery management algorithm 330, or any other component described with reference to FIGS. 1-7 above or with reference to FIGS. 9-11 below. The computing device 800 includes one or more processors 802 which, individually, as a subgroup, or in combination, may be configured to execute or implement software, hardware, and/or firmware modules that perform any functionality described above with reference to the premises environment platform 100, the control panel 101, the intrusion/security system 102, the fire protection system 106, the access control system 104, the building controls system 108, the cloud system 110, the fire panel 312, the intrusion/security panel 314, the loop interface module(s) 316, the repeater module(s) 318, the expander module(s) 320, the one or more processors 302, the battery management algorithm 330, the access control panel 315, the access control reader 319, the access control lock 321, or any other component described with reference to FIGS. 1-7 above or with reference to FIGS. 9-11 below. For example, the computing device 800 may implement the control panel 101, in which case the one or more processors 802 may be the one or more processors 302 that, individually, as a subgroup, or in combination, are configured to execute the battery management algorithm 330 to perform any battery management functionality described herein, such as, but not limited to, any battery management functionality described with reference to FIGS. 1-7 above or with reference to FIGS. 9-11 below.

The one or more processors 802 may be a micro-controller and/or may include a single or multiple set of processors or multi-core processors. Moreover, the one or more processors 802 may be implemented as an integrated processing system and/or a distributed processing system. The computing device 800 may further include one or more memories 804, such as for storing local versions of applications being executed by the one or more processors 802, related instructions, parameters, etc. The one or more memories 804 may include a type of memory usable by a computer, such as random access memory (RAM), read only memory (ROM), tapes, magnetic discs, optical discs, volatile memory, non-volatile memory, and any combination thereof. Additionally, the one or more processors 802 and the one or more memories 804 may include and execute an operating system executing on the one or more processors 802, individually, as a subgroup, or in combination, one or more applications, display drivers, etc., and/or other components of the computing device 800.

Further, the computing device 800 may include a communications component 806 that provides for establishing and maintaining communications with one or more other devices, parties, entities, etc., utilizing hardware, software, and services. The communications component 806 may carry communications between components on the computing device 800, as well as between the computing device 800 and external devices, such as devices located across a communications network and/or devices serially or locally connected to the computing device 800. For example, the communications component 806 may include one or more buses, and may further include transmit chain components and receive chain components associated with a wireless or wired transmitter and receiver, respectively, operable for interfacing with external devices.

Additionally, the computing device 800 may include a data store 808, which can be any suitable combination of hardware and/or software, that provides for mass storage of information, databases, and programs. For example, the data store 808 may be or may include a data repository for applications and/or related parameters not currently being executed by the one or more processors 802, individually, as a subgroup, or in combination. In addition, the data store 808 may be a data repository for an operating system, application, display driver, etc., executing on the one or more processors 802, individually, as a subgroup, or in combination, and/or one or more other components of the computing device 800.

The computing device 800 may also include a user interface component 810 operable to receive inputs from a user of the computing device 800 and further operable to generate outputs for presentation to the user (e.g., via a display interface to a display device). The user interface component 810 may include one or more input devices, including but not limited to a keyboard, a number pad, a mouse, a touch-sensitive display, a navigation key, a function key, a microphone, a voice recognition component, or any other mechanism capable of receiving an input from a user, or any combination thereof. Further, the user interface component 810 may include one or more output devices, including but not limited to a display interface, a speaker, a haptic feedback mechanism, a printer, any other mechanism capable of presenting an output to a user, or any combination thereof.

Referring to FIGS. 9-11, in operation for battery management functionality, computing device 800 may implement at least a portion of one or more components in FIGS. 1-8 above, such as all or at least a portion of control panel 101, one or more processors 302 individually, as a subgroup, or in combination, battery management algorithm 330, one or more processors 802 individually, as a subgroup, or in combination, one or more memories 804 individually, as a subgroup, or in combination, or any other component configured for providing battery management functionality. In this case, the computing device 800 may perform any one or any combination of methods 900, 1000, 1100 such as via execution of battery management algorithm 330 by one or more processors 302 individually, as a subgroup, or in combination, one or more processors 802 individually, as a subgroup, or in combination, and/or one or more memories 804 individually, as a subgroup, or in combination. Specifically, computing device 800 may be configured to perform any one or any combination of methods 900, 1000, 1100 for performing an aspect of battery management functionality, as described herein.

It should be noted that in some aspects, computing device 800 and one or more processors 802 may be the same or similar to control panel 101 and one or more processors 302 as described above with respect to FIG. 2. For example, in some aspects, the control panel 101 may perform any one or any combination of the methods 900, 1000, 1100, such as via execution of the one or more processors 302 (individually, as a subgroup, or in combination) and/or the battery management algorithm 330. In these aspects, the control panel 101 is configured to control two or more premises safety or automation systems of a premises (e.g., 102, 104, 106, etc.), and comprises a first connection (e.g., 313) connectable to supply power to one or more first devices (e.g., 312, 316) of a first premises safety or automation system (e.g., 106); a second connection (e.g., 317) connectable to supply power to one or more second devices (e.g., 314, 318, 320) of a second premises safety or automation system (e.g., 102); and/or a third connection (e.g., 322) connectable to supply power to one or more third devices (e.g., 315, 319, 321) of a third premises safety or automation system (e.g., 104).

Referring to FIG. 9, at 902 the method 900 includes entering a standby mode in which the first connection and the second connection supply battery backup power to the one or more first devices of the first premises safety or automation system and the one or more second devices of the second premises safety or automation system. For example, in an aspect, computing device 800, one or more processors 802 individually, as a subgroup, or in combination, one or more memories 804 individually, as a subgroup, or in combination, control panel 101, one or more processors 302 individually, as a subgroup, or in combination, and/or battery management algorithm 330 may be configured to or may comprise means for entering a standby mode in which the first connection and the second connection supply battery backup power to the one or more first devices of the first premises safety or automation system and the one or more second devices of the second premises safety or automation system.

For example, in an aspect where the control panel 101 controls the fire protection system 106 and the access control system 104, upon losing a mains supply power, the control panel 101 may enter a standby mode in which the first connection 313 and the third connection 322 supply battery backup power to devices of the fire protection system 106 and devices of the access control system 104, respectively. Similarly, in an aspect where the control panel 101 controls the intrusion/security system 102 and the access control system 104, upon losing a mains supply power, the control panel 101 may enter a standby mode in which the second connection 317 and the third connection 322 supply battery backup power to devices of the intrusion/security system 102 and devices of the access control system 104, respectively.

Optionally, block 902 may include optional block 904, and at optional block 904 the method 900 may include entering the standby mode in which the first connection, the second connection, and the third connection supply battery backup power to the one or more first devices of the first premises safety or automation system, the one or more second devices of the second premises safety or automation system, and the one or more third devices of the third premises safety or automation system. For example, in an aspect, computing device 800, one or more processors 802 individually, as a subgroup, or in combination, one or more memories 804 individually, as a subgroup, or in combination, control panel 101, one or more processors 302 individually, as a subgroup, or in combination, and/or battery management algorithm 330 may be configured to or may comprise means for entering the standby mode in which the first connection, the second connection, and the third connection supply battery backup power to the one or more first devices of the first premises safety or automation system, the one or more second devices of the second premises safety or automation system, and the one or more third devices of the third premises safety or automation system.

For example, in an aspect where the control panel 101 controls the fire protection system 106, the intrusion/security system 102, and the access control system 104, upon losing a mains supply power, the control panel 101 may enter a standby mode in which the first connection 313, the second connection 317, and the third connection 322 supply battery backup power to devices of the fire protection system 106, devices of the intrusion/security system 102, and devices of the access control system 104, respectively.

At block 906 the method 900 includes disconnecting the second connection to cease supplying the battery backup power to the one or more second devices of the second premises safety or automation system upon expiration of the second standby time requirement, while keeping the first connection to continue supplying the battery backup power to the one or more first devices of the first premises safety or automation system. For example, in an aspect, computing device 800, one or more processors 802 individually, as a subgroup, or in combination, one or more memories 804 individually, as a subgroup, or in combination, control panel 101, one or more processors 302 individually, as a subgroup, or in combination, and/or battery management algorithm 330 may be configured to or may comprise means for disconnecting the second connection to cease supplying the battery backup power to the one or more second devices of the second premises safety or automation system upon expiration of the second standby time requirement, while keeping the first connection to continue supplying the battery backup power to the one or more first devices of the first premises safety or automation system.

For example, in an aspect where the control panel 101 controls the fire protection system 106 having a first standby time requirement (e.g., 24 hours) and the access control system 104 having a second standby time requirement (e.g., 4 hours), upon expiration of the second standby time requirement, the control panel 101 may disconnect the third connection 322 to cease supplying battery backup power to devices of the access control system 104, while keeping the first connection 313 to continue supplying the battery backup power to devices of the fire protection system 106. Similarly, in an aspect where the control panel 101 controls the intrusion/security system 102 having a first standby time requirement (e.g., 24 hours) and the access control system 104 having a second standby time requirement (e.g., 4 hours), upon expiration of the second standby time requirement, the control panel 101 may disconnect the third connection 322 to cease supplying battery backup power to devices of the access control system 104, while keeping the second connection 317 to continue supplying the battery backup power to devices of the intrusion/security system 102.

Optionally block 906 may include optional block 908, and at optional block 908 the method 900 may include disconnecting the second connection to cease supplying the battery backup power to the one or more second devices of the second premises safety or automation system upon expiration of the second standby time requirement, while keeping the first connection and the third connection to continue supplying the battery backup power to the one or more first devices of the first premises safety or automation system and the one or more third devices of the third premises safety or automation system. For example, in an aspect, computing device 800, one or more processors 802 individually, as a subgroup, or in combination, one or more memories 804 individually, as a subgroup, or in combination, control panel 101, one or more processors 302 individually, as a subgroup, or in combination, and/or battery management algorithm 330 may be configured to or may comprise means for disconnecting the second connection to cease supplying the battery backup power to the one or more second devices of the second premises safety or automation system upon expiration of the second standby time requirement, while keeping the first connection and the third connection to continue supplying the battery backup power to the one or more first devices of the first premises safety or automation system and the one or more third devices of the third premises safety or automation system.

For example, in an aspect where the control panel controls the fire protection system 106 having a first standby time requirement (e.g., 24 hours), the intrusion/security system 102 having a second standby time requirement (e.g., 72 hours), and the access control system 104 having a third standby time requirement (e.g., 4 hours), upon expiration of the third standby time requirement, the control panel 101 may disconnect the third connection 322 to cease supplying battery backup power to devices of the access control system 104, while keeping the first connection 313 and the second connection 317 to continue supplying the battery backup power to devices of the fire protection system 106 and the devices of the intrusion/security system 102, respectively.

Optionally, at block 910 the method 900 may further include disconnecting the third connection to cease supplying the battery backup power to the one or more third devices of the third premises safety or automation system upon expiration of the third standby time requirement, while keeping the first connection to continue supplying the battery backup power to the one or more first devices of the first premises safety or automation system. For example, in an aspect, computing device 800, one or more processors 802 individually, as a subgroup, or in combination, one or more memories 804 individually, as a subgroup, or in combination, control panel 101, one or more processors 302 individually, as a subgroup, or in combination, and/or battery management algorithm 330 may be configured to or may comprise means for disconnecting the third connection to cease supplying the battery backup power to the one or more third devices of the third premises safety or automation system upon expiration of the third standby time requirement, while keeping the first connection to continue supplying the battery backup power to the one or more first devices of the first premises safety or automation system.

For example, in an aspect where the control panel controls the fire protection system 106 having a first standby time requirement (e.g., 24 hours), the intrusion/security system 102 having a second standby time requirement (e.g., 72 hours), and the access control system 104 having a third standby time requirement (e.g., 4 hours), subsequent to disconnecting the third connection 322 upon expiration of the third standby time requirement, and further upon expiration of the first standby time requirement, the control panel 101 may further disconnect the first connection 313 to cease supplying battery backup power to devices of the fire protection system 106, while keeping the second connection 310 to continue supplying the battery backup power to devices of the intrusion/security system 102.

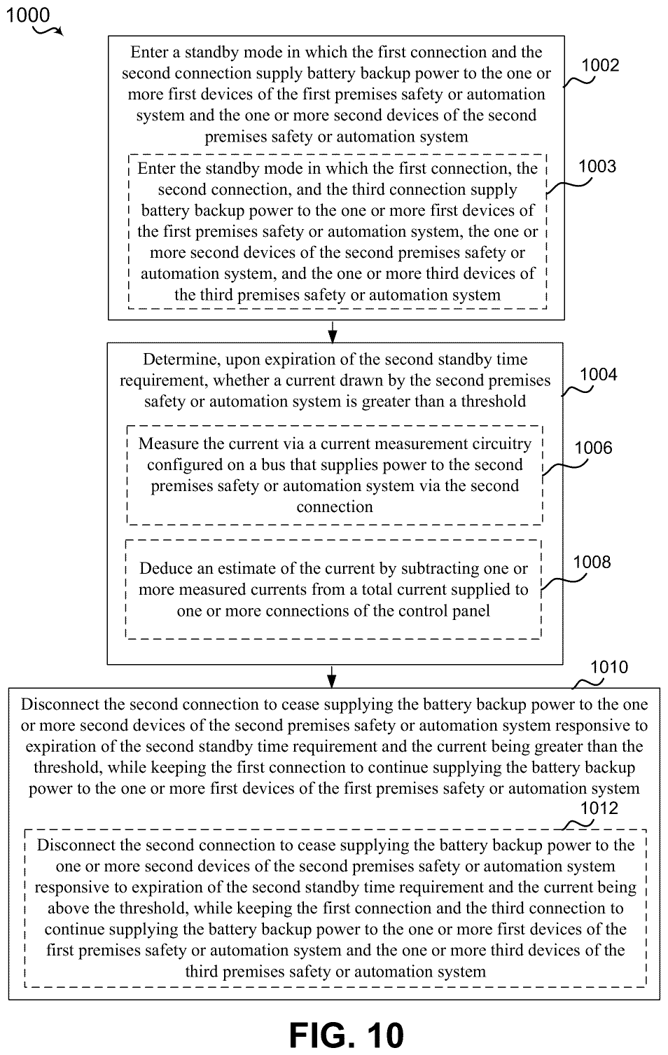

Referring to FIG. 10, at block 1002 the method 1000 includes entering a standby mode in which the first connection and the second connection supply battery backup power to the one or more first devices of the first premises safety or automation system and the one or more second devices of the second premises safety or automation system. For example, in an aspect, computing device 800, one or more processors 802 individually, as a subgroup, or in combination, one or more memories 804 individually, as a subgroup, or in combination, control panel 101, one or more processors 302 individually, as a subgroup, or in combination, and/or battery management algorithm 330 may be configured to or may comprise means for entering a standby mode in which the first connection and the second connection supply battery backup power to the one or more first devices of the first premises safety or automation system and the one or more second devices of the second premises safety or automation system.

For example, in an aspect where the control panel 101 controls the fire protection system 106 and the access control system 104, upon losing a mains supply power, the control panel 101 may enter a standby mode in which the first connection 313 and the third connection 322 supply battery backup power to devices of the fire protection system 106 and devices of the access control system 104, respectively. Similarly, in an aspect where the control panel 101 controls the intrusion/security system 102 and the access control system 104, upon losing a mains supply power, the control panel 101 may enter a standby mode in which the second connection 317 and the third connection 322 supply battery backup power to devices of the intrusion/security system 102 and devices of the access control system 104, respectively.

Optionally, block 1002 may include optional block 1003, and at optional block 1003 the method 1000 may include entering the standby mode in which the first connection, the second connection, and the third connection supply battery backup power to the one or more first devices of the first premises safety or automation system, the one or more second devices of the second premises safety or automation system, and the one or more third devices of the third premises safety or automation system. For example, in an aspect, computing device 800, one or more processors 802 individually, as a subgroup, or in combination, one or more memories 804 individually, as a subgroup, or in combination, control panel 101, one or more processors 302 individually, as a subgroup, or in combination, and/or battery management algorithm 330 may be configured to or may comprise means for entering the standby mode in which the first connection, the second connection, and the third connection supply battery backup power to the one or more first devices of the first premises safety or automation system, the one or more second devices of the second premises safety or automation system, and the one or more third devices of the third premises safety or automation system.

For example, in an aspect where the control panel 101 controls the fire protection system 106, the intrusion/security system 102, and the access control system 104, upon losing a mains supply power, the control panel 101 may enter a standby mode in which the first connection 313, the second connection 317, and the third connection 322 supply battery backup power to devices of the fire protection system 106, devices of the intrusion/security system 102, and devices of the access control system 104, respectively.

At block 1004 the method 1000 include determining, upon expiration of the second standby time requirement, whether a current drawn by the second premises safety or automation system is greater than a threshold. For example, in an aspect, computing device 800, one or more processors 802 individually, as a subgroup, or in combination, one or more memories 804 individually, as a subgroup, or in combination, control panel 101, one or more processors 302 individually, as a subgroup, or in combination, and/or battery management algorithm 330 may be configured to or may comprise means for determining, upon expiration of the second standby time requirement, whether a current drawn by the second premises safety or automation system is greater than a threshold.

For example, upon expiration of a 4 hour standby time requirement of the access control system 104, the control panel 101 may determine whether a current drawn by the access control system 104 is greater than a threshold such as 100 milliamps.

Optionally, block 1004 may include optional block 1006, and at optional block 1006 the method 1000 may include measuring the current via a current measurement circuitry configured on a bus that supplies power to the second premises safety or automation system via the second connection. For example, in an aspect, computing device 800, one or more processors 802 individually, as a subgroup, or in combination, one or more memories 804 individually, as a subgroup, or in combination, control panel 101, one or more processors 302 individually, as a subgroup, or in combination, and/or battery management algorithm 330 may be configured to or may comprise means for measuring the current via a current measurement circuitry configured on a bus that supplies power to the second premises safety or automation system via the second connection.

For example, in one optional aspect, the control panel 101 may use current measurement functionality in the third control circuitry 307 to measure the current drawn by the access control system 104.

Optionally, block 1004 may include optional block 1008, and at optional block 1008 the method 1000 may include deducing an estimate of the current by subtracting one or more measured currents from a total current supplied to one or more connections of the control panel. For example, in an aspect, computing device 800, one or more processors 802 individually, as a subgroup, or in combination, one or more memories 804 individually, as a subgroup, or in combination, control panel 101, one or more processors 302 individually, as a subgroup, or in combination, and/or battery management algorithm 330 may be configured to or may comprise means for deducing an estimate of the current by subtracting one or more measured currents from a total current supplied to one or more connections of the control panel.

For example, in one optional aspect, where the third control circuitry 307 does not include current measurement functionality, the control panel 101 may subtract the currents measured by the first current measurement/control circuitry 304 and the second current measurement/control circuitry 306 from a total current supplied to the connections of the control panel 101, to deduce an estimate of the current drawn by the access control system 104 via the third connection 311.

At block 1010 the method 1000 includes disconnecting the second connection to cease supplying the battery backup power to the one or more second devices of the second premises safety or automation system responsive to expiration of the second standby time requirement and the current being greater than the threshold, while keeping the first connection to continue supplying the battery backup power to the one or more first devices of the first premises safety or automation system. For example, in an aspect, computing device 800, one or more processors 802 individually, as a subgroup, or in combination, one or more memories 804 individually, as a subgroup, or in combination, control panel 101, one or more processors 302 individually, as a subgroup, or in combination, and/or battery management algorithm 330 may be configured to or may comprise means for disconnecting the second connection to cease supplying the battery backup power to the one or more second devices of the second premises safety or automation system responsive to expiration of the second standby time requirement and the current being greater than the threshold, while keeping the first connection to continue supplying the battery backup power to the one or more first devices of the first premises safety or automation system.

For example, after expiration of the 4 hour standby time requirement of the access control system 104, if the current drawn by the access control system 104 is higher than the 100 milliamps threshold, the control panel 101 may disconnect the third connection 322 to cease supplying the battery backup power to devices of the access control system 104, while keeping one or more other connections (e.g., 313, 317) to continue supplying the battery backup power to devices of one or more other premises safety or automation systems (e.g., 106, 102).

Optionally, block 1010 may include optional block 1012, and at optional block 1012 the method 1000 may include disconnecting the second connection to cease supplying the battery backup power to the one or more second devices of the second premises safety or automation system responsive to expiration of the second standby time requirement and the current being greater than the threshold, while keeping the first connection and the third connection to continue supplying the battery backup power to the one or more first devices of the first premises safety or automation system and the one or more third devices of the third premises safety or automation system, respectively. For example, in an aspect, computing device 800, one or more processors 802 individually, as a subgroup, or in combination, one or more memories 804 individually, as a subgroup, or in combination, control panel 101, one or more processors 302 individually, as a subgroup, or in combination, and/or battery management algorithm 330 may be configured to or may comprise means for disconnecting the second connection to cease supplying the battery backup power to the one or more second devices of the second premises safety or automation system responsive to expiration of the second standby time requirement and the current being greater than the threshold, while keeping the first connection and the third connection to continue supplying the battery backup power to the one or more first devices of the first premises safety or automation system and the one or more third devices of the third premises safety or automation system, respectively.

For example, upon expiration of the 4 hour standby requirement of the access control system 104, if the current drawn by the access control system 104 is higher than the 100 milliamps threshold, the control panel 101 may disconnect the third connection 322 to cease supplying the battery backup power to devices of the access control system 104, while keeping the first connection 313 and the second connection 317 to continue supplying the battery backup power to devices of the fire protection system 106 and the intrusion/security 102, respectively.

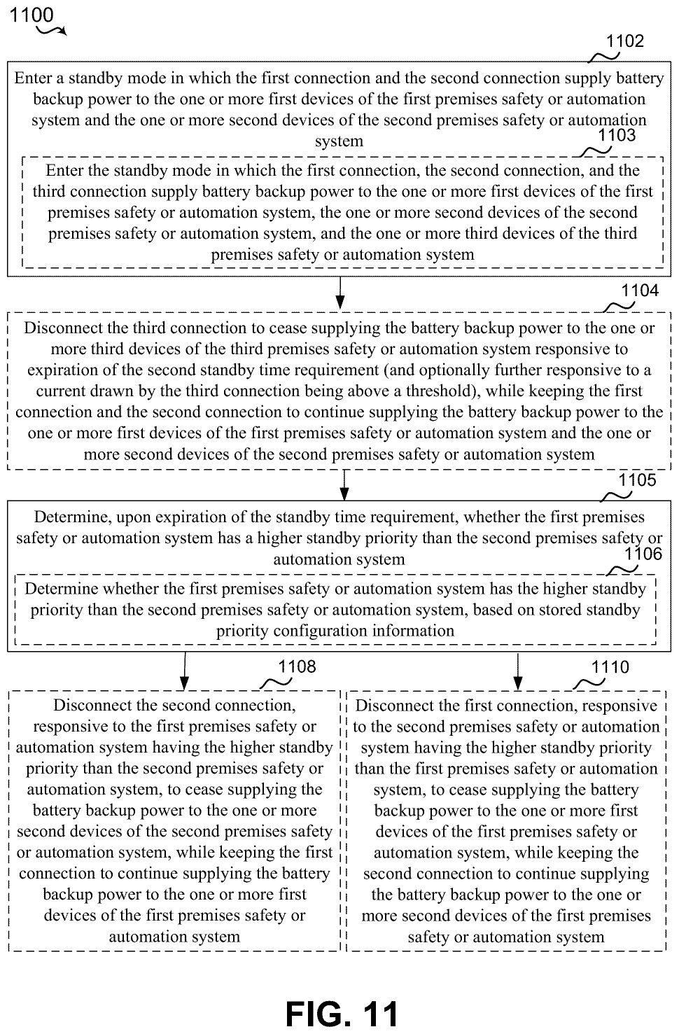

Referring to FIG. 11, at block 1102, the method 1100 includes entering a standby mode in which the first connection and the second connection supply battery backup power to the one or more first devices of the first premises safety or automation system and the one or more second devices of the second premises safety or automation system. For example, in an aspect, computing device 800, one or more processors 802 individually, as a subgroup, or in combination, one or more memories 804 individually, as a subgroup, or in combination, control panel 101, one or more processors 302 individually, as a subgroup, or in combination, and/or battery management algorithm 330 may be configured to or may comprise means for entering a standby mode in which the first connection and the second connection supply battery backup power to the one or more first devices of the first premises safety or automation system and the one or more second devices of the second premises safety or automation system.

For example, in an aspect where the control panel 101 controls the fire protection system 106 and the intrusion/security system 102 having a same standby time requirement (e.g., 24 hours), upon losing a mains supply power, the control panel 101 may enter a standby mode in which the first connection 313 and the second connection 317 supply battery backup power to devices of the fire protection system 106 and devices of the intrusion/security system 102, respectively.

Optionally, block 1102 may include optional block 1103, and at optional block 1103 the method 1100 may include entering the standby mode in which the first connection, the second connection, and the third connection supply battery backup power to the one or more first devices of the first premises safety or automation system, the one or more second devices of the second premises safety or automation system, and the one or more third devices of the third premises safety or automation system. For example, in an aspect, computing device 800, one or more processors 802 individually, as a subgroup, or in combination, one or more memories 804 individually, as a subgroup, or in combination, control panel 101, one or more processors 302 individually, as a subgroup, or in combination, and/or battery management algorithm 330 may be configured to or may comprise means for entering the standby mode in which the first connection, the second connection, and the third connection supply battery backup power to the one or more first devices of the first premises safety or automation system, the one or more second devices of the second premises safety or automation system, and the one or more third devices of the third premises safety or automation system.

For example, in an aspect where the control panel 101 controls the fire protection system 106, the intrusion/security system 102, and the access control system 104, upon losing a mains supply power, the control panel 101 may enter a standby mode in which the first connection 313, the second connection 317, and the third connection 322 supply battery backup power to devices of the fire protection system 106, devices of the intrusion/security system 102, and devices of the access control system 104, respectively.

Optionally, at optional block 1104, the method 1100 may include disconnecting the third connection to cease supplying the battery backup power to the one or more third devices of the third premises safety or automation system upon expiration of the second standby time requirement (and optionally further responsive to a current drawn by the third connection being above a threshold), while keeping the first connection and the second connection to continue supplying the battery backup power to the one or more first devices of the first premises safety or automation system and the one or more second devices of the second premises safety or automation system. For example, in an aspect, computing device 800, one or more processors 802 individually, as a subgroup, or in combination, one or more memories 804 individually, as a subgroup, or in combination, control panel 101, one or more processors 302 individually, as a subgroup, or in combination, and/or battery management algorithm 330 may be configured to or may comprise means for disconnecting the third connection to cease supplying the battery backup power to the one or more third devices of the third premises safety or automation system upon expiration of the second standby time requirement (and optionally further responsive to a current drawn by the third connection being above a threshold), while keeping the first connection and the second connection to continue supplying the battery backup power to the one or more first devices of the first premises safety or automation system and the one or more second devices of the second premises safety or automation system.

For example, in an aspect where the control panel controls the fire protection system 106 and the intrusion/security system 102 (both having a 24 hour standby time requirement, e.g., in a residential building) and the access control system 104 (having a 4 hour standby time requirement), upon expiration of the 4 hour standby time requirement, the control panel 101 may disconnect the third connection 322 to cease supplying battery backup power to devices of the access control system 104, while keeping the first connection 313 and the second connection 317 to continue supplying the battery backup power to devices of the fire protection system 106 and the devices of the intrusion/security system 102, respectively.

At block 1105, the method 1100 includes determining, upon expiration of the second standby time requirement, whether the first premises safety or automation system has a higher standby priority than the second premises safety or automation system. For example, in an aspect, computing device 800, one or more processors 802 individually, as a subgroup, or in combination, one or more memories 804 individually, as a subgroup, or in combination, control panel 101, one or more processors 302 individually, as a subgroup, or in combination, and/or battery management algorithm 330 may be configured to or may comprise means for determining, upon expiration of the second standby time requirement, whether the first premises safety or automation system has a higher standby priority than the second premises safety or automation system.

For example, upon expiration of the 24 hour standby time requirement of the fire protection system 106 and the intrusion/security system 10, the control panel 101 may determine which one of the fire protection system 106 and the intrusion/security system 102 has a higher standby priority.

Optionally, block 1105 may further include optional block 1106, and at optional block 1106 the method 1100 may further include determining whether the first premises safety or automation system has the higher standby priority than the second premises safety or automation system, based on stored standby priority configuration information. For example, in an aspect, computing device 800, one or more processors 802 individually, as a subgroup, or in combination, one or more memories 804 individually, as a subgroup, or in combination, control panel 101, one or more processors 302 individually, as a subgroup, or in combination, and/or battery management algorithm 330 may be configured to or may comprise means for determining whether the first premises safety or automation system has the higher standby priority than the second premises safety or automation system, based on stored standby priority configuration information.

For example, upon expiration of the 24 hour standby time requirement of the fire protection system 106 and the intrusion/security system 10, the control panel 101 may use stored standby priority configuration information to determine which one of the fire protection system 106 and the intrusion/security system 102 has a higher standby priority.

Optionally, at block 1108 the method 1100 may further include disconnecting the second connection, responsive to the first premises safety or automation system having the higher standby priority than the second premises safety or automation system, to cease supplying the battery backup power to the one or more second devices of the second premises safety or automation system, while keeping the first connection to continue supplying the battery backup power to the one or more first devices of the first premises safety or automation system. For example, in an aspect, computing device 800, one or more processors 802 individually, as a subgroup, or in combination, one or more memories 804 individually, as a subgroup, or in combination, control panel 101, one or more processors 302 individually, as a subgroup, or in combination, and/or battery management algorithm 330 may be configured to or may comprise means for disconnecting the second connection, responsive to the first premises safety or automation system having the higher standby priority than the second premises safety or automation system, to cease supplying the battery backup power to the one or more second devices of the second premises safety or automation system, while keeping the first connection to continue supplying the battery backup power to the one or more first devices of the first premises safety or automation system.

For example, if the fire protection system 106 has a higher standby priority than the intrusion/security system 102, the control panel 101 may disconnect the second connection 317 to cease supplying the battery backup power to devices of the intrusion/security system 102, while keeping the first connection 313 to continue supplying the battery backup power to devices of the fire protection system 106. Similarly, if the fire protection system 106 has a lower standby priority than the intrusion/security system 102, the control panel 101 may disconnect the first connection 313 to cease supplying the battery backup power to devices of the fire protection system 106, while keeping the second connection 317 to continue supplying the battery backup power to devices of the intrusion/security system 102.

Optionally, at block 1110 the method 1100 further includes disconnecting the first connection, responsive to the second premises safety or automation system having the higher standby priority than the first premises safety or automation system, to cease supplying the battery backup power to the one or more first devices of the first premises safety or automation system, while keeping the second connection to continue supplying the battery backup power to the one or more second devices of the second premises safety or automation system. For example, in an aspect, computing device 800, one or more processors 802 individually, as a subgroup, or in combination, one or more memories 804 individually, as a subgroup, or in combination, control panel 101, one or more processors 302 individually, as a subgroup, or in combination, and/or battery management algorithm 330 may be configured to or may comprise means for disconnecting the first connection, responsive to the second premises safety or automation system having the higher standby priority than the first premises safety or automation system, to cease supplying the battery backup power to the one or more first devices of the first premises safety or automation system, while keeping the second connection to continue supplying the battery backup power to the one or more second devices of the second premises safety or automation system.

For example, if the fire protection system 106 has a higher standby priority than the intrusion/security system 102, the control panel 101 may disconnect the second connection 317 to cease supplying the battery backup power to devices of the intrusion/security system 102, while keeping the first connection 313 to continue supplying the battery backup power to devices of the fire protection system 106. Similarly, if the fire protection system 106 has a lower standby priority than the intrusion/security system 102, the control panel 101 may disconnect the first connection 313 to cease supplying the battery backup power to devices of the fire protection system 106, while keeping the second connection 317 to continue supplying the battery backup power to devices of the intrusion/security system 102.

Another example aspect includes an apparatus comprising one or more memories storing instructions, and one or more processors coupled with the one or more memories. The one or more processors, individually, as a subgroup, or in combination, are configured to execute the instructions to perform any battery management functionality described herein.

Another example aspect includes an apparatus comprising means for perform any battery management functionality described herein.

Another example aspect includes one or more computer-readable media having instructions stored thereon, wherein the instructions are executable by one or more processors, individually, as a subgroup, or in combination, to perform any battery management functionality described herein.

Some further aspects are provided below in the form of clauses.
1. A control panel configured to control two or more premises safety or automation systems of a premises, the control panel comprising:
a first connection connectable to supply power to one or more first devices of a first premises safety or automation system having a first standby time requirement;
a second connection connectable to supply power to one or more second devices of a second premises safety or automation system having a second standby time requirement that is less than the first standby time requirement; and
one or more processors that, individually, as a subgroup, or in combination, are configured to:
enter a standby mode in which the first connection and the second connection supply battery backup power to the one or more first devices of the first premises safety or automation system and the one or more second devices of the second premises safety or automation system; and
disconnect the second connection to cease supplying the battery backup power to the one or more second devices of the second premises safety or automation system upon expiration of the second standby time requirement, while keeping the first connection to continue supplying the battery backup power to the one or more first devices of the first premises safety or automation system.
2. The control panel of clause 1,
wherein the second premises safety or automation system comprises an access control system; and/or
wherein the first premises safety or automation system comprises an intrusion/security system or a fire protection system.
3. The control panel of clause 1, further comprising a third connection connectable to supply power to one or more third devices of a third premises safety or automation system having a third standby time requirement that is more than the second standby time requirement.
4. The control panel of clause 3, wherein the one or more processors, individually, as a subgroup, or in combination, are further configured to enter the standby mode in which the first connection, the second connection, and the third connection supply battery backup power to the one or more first devices of the first premises safety or automation system, the one or more second devices of the second premises safety or automation system, and the one or more third devices of the third premises safety or automation system.
5. The control panel of clause 4, wherein the one or more processors, individually, as a subgroup, or in combination, are further configured to disconnect the second connection to cease supplying the battery backup power to the one or more second devices of the second premises safety or automation system upon expiration of the second standby time requirement, while keeping the first connection and the third connection to continue supplying the battery backup power to the one or more first devices of the first premises safety or automation system and the one or more third devices of the third premises safety or automation system.
6. The control panel of clause 5,
wherein the second premises safety or automation system comprises an access control system; and/or
wherein the third standby time requirement is less than the first standby time requirement.
7. The control panel of clause 6, wherein the one or more processors, individually, as a subgroup, or in combination, are further configured to disconnect the third connection to cease supplying the battery backup power to the one or more third devices of the third premises safety or automation system upon expiration of the third standby time requirement, while keeping the first connection to continue supplying the battery backup power to the one or more first devices of the first premises safety or automation system.
8. The control panel of clause 7,
wherein the first premises safety or automation system comprises an intrusion/security system and the third premises safety or automation system comprises a fire protection system; or
wherein the third premises safety or automation system comprises an intrusion/security system and the first premises safety or automation system comprises a fire protection system.
9. A control panel configured to control two or more premises safety or automation systems of a premises, the control panel comprising:
a first connection connectable to supply power to one or more first devices of a first premises safety or automation system having a first standby time requirement;
a second connection connectable to supply power to one or more second devices of a second premises safety or automation system having a second standby time requirement that is less than the first standby time requirement; and
one or more processors that, individually, as a subgroup, or in combination, are configured to:
enter a standby mode in which the first connection and the second connection supply battery backup power to the one or more first devices of the first premises safety or automation system and the one or more second devices of the second premises safety or automation system;
determine, upon expiration of the second standby time requirement, whether a current drawn by the second premises safety or automation system is greater than a threshold; and

disconnect the second connection to cease supplying the battery backup power to the one or more second devices of the second premises safety or automation system responsive to expiration of the second standby time requirement and the current being greater than the threshold, while keeping the first connection to continue supplying the battery backup power to the one or more first devices of the first premises safety or automation system.
10. The control panel of clause 9, wherein to determine whether the current drawn by the second premises safety or automation system is greater than the threshold, the one or more processors, individually, as a subgroup, or in combination, are configured to:
measure the current via a current measurement circuitry configured on a bus that supplies power to the second premises safety or automation system via the second connection; or
deduce an estimate of the current by subtracting one or more measured currents from a total current supplied to one or more connections of the control panel.
11. The control panel of clause 9 or 10,
wherein the second premises safety or automation system comprises an access control system; and/or
wherein the first premises safety or automation system comprises an intrusion/security system or a fire protection system.
12. The control panel of any one of clauses 9 to 11, further comprising a third connection connectable to supply power to one or more third devices of a third premises safety or automation system having a third standby time requirement that is more than the second standby time requirement.
13. The control panel of clause 12, wherein the one or more processors, individually, as a subgroup, or in combination, are further configured to enter the standby mode in which the first connection, the second connection, and the third connection supply battery backup power to the one or more first devices of the first premises safety or automation system, the one or more second devices of the second premises safety or automation system, and the one or more third devices of the third premises safety or automation system.
14. The control panel of clause 13, wherein the one or more processors, individually, as a subgroup, or in combination, are further configured to disconnect the second connection to cease supplying the battery backup power to the one or more second devices of the second premises safety or automation system responsive to expiration of the second standby time requirement and the current being greater than the threshold, while keeping the first connection and the third connection to continue supplying the battery backup power to the one or more first devices of the first premises safety or automation system and the one or more third devices of the third premises safety or automation system.
15. A control panel configured to control two or more premises safety or automation systems of a premises, the control panel comprising:
a first connection connectable to supply power to one or more first devices of a first premises safety or automation system having a first standby time requirement;
a second connection connectable to supply power to one or more second devices of a second premises safety or automation system having a second standby time requirement equal to the first standby time requirement; and
one or more processors that, individually, as a subgroup, or in combination, are configured to:
enter a standby mode in which the first connection and the second connection supply battery backup power to the one or more first devices of the first premises safety or automation system and the one or more second devices of the second premises safety or automation system;
determine, upon expiration of the second standby time requirement, whether the first premises safety or automation system has a higher standby priority than the second premises safety or automation system;
disconnect the second connection, responsive to the first premises safety or automation system having the higher standby priority than the second premises safety or automation system, to cease supplying the battery backup power to the one or more second devices of the second premises safety or automation system, while keeping the first connection to continue supplying the battery backup power to the one or more first devices of the first premises safety or automation system; and
disconnect the first connection, responsive to the second premises safety or automation system having the higher standby priority than the first premises safety or automation system, to cease supplying the battery backup power to the one or more first devices of the first premises safety or automation system, while keeping the second connection to continue supplying the battery backup power to the one or more second devices of the second premises safety or automation system.
16. The control panel of clause 15,
wherein the first premises safety or automation system comprises an intrusion/security system and the second premises safety or automation system comprises a fire protection system; or
wherein the second premises safety or automation system comprises an intrusion/security system and the first premises safety or automation system comprises a fire protection system.
17. The control panel of clause 15 or 16, further comprising a third connection connectable to supply power to one or more third devices of a third premises safety or automation system having a third standby time requirement that is less than the standby time requirement.
18. The control panel of clause 17, wherein the one or more processors, individually, as a subgroup, or in combination, are further configured to:
enter the standby mode in which the first connection, the second connection, and the third connection supply battery backup power to the one or more first devices of the first premises safety or automation system, the one or more second devices of the second premises safety or automation system, and the one or more third devices of the third premises safety or automation system; and
disconnect the third connection to cease supplying the battery backup power to the one or more third devices of the third premises safety or automation system responsive to expiration of the third standby time requirement, while keeping the first connection and the second connection to continue supplying the battery backup power to the one or more first devices of the first premises safety or automation system and the one or more second devices of the second premises safety or automation system.
19. The control panel of clause 17, wherein the one or more processors, individually, as a subgroup, or in combination, are further configured to:
enter the standby mode in which the first connection, the second connection, and the third connection supply battery backup power to the one or more first devices of the first premises safety or automation system, the one or more second devices of the second premises safety or automation system, and the one or more third devices of the third premises safety or automation system; and
disconnect the third connection to cease supplying the battery backup power to the one or more third devices of the third premises safety or automation system responsive to expiration of the third standby time requirement and a current drawn by the third connection being above a threshold, while keeping the first connection and the second connection to continue supplying the battery backup power to the one or more first devices of the first premises safety or automation system and the one or more second devices of the second premises safety or automation system.
20. The control panel of any one of clauses 15 to 19, wherein the one or more processors, individually, as a subgroup, or in combination, are configured to determine whether the first premises safety or automation system has the higher standby priority than the second premises safety or automation system, based on stored standby priority configuration information.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A control panel configured to control two or more premises safety or automation systems of a premises, the control panel comprising:
a first connection connectable to supply power to one or more first devices of a first premises safety or automation system having a first standby time requirement;
a second connection connectable to supply power to one or more second devices of a second premises safety or automation system having a second standby time requirement that is less than the first standby time requirement; and
one or more processors that, individually, as a subgroup, or in combination, are configured to:
enter a standby mode in which the first connection and the second connection supply battery backup power to the one or more first devices of the first premises safety or automation system and the one or more second devices of the second premises safety or automation system; and
disconnect the second connection to cease supplying the battery backup power to the one or more second devices of the second premises safety or automation system upon expiration of the second standby time requirement, while keeping the first connection to continue supplying the battery backup power to the one or more first devices of the first premises safety or automation system.

2. The control panel of claim 1,
wherein the second premises safety or automation system comprises an access control system; and/or wherein the first premises safety or automation system comprises an intrusion/security system or a fire protection system.

3. The control panel of claim 1, further comprising a third connection connectable to supply power to one or more third devices of a third premises safety or automation system having a third standby time requirement that is more than the second standby time requirement.

4. The control panel of claim 3, wherein the one or more processors, individually, as a subgroup, or in combination, are further configured to enter the standby mode in which the first connection, the second connection, and the third connection supply battery backup power to the one or more first devices of the first premises safety or automation system, the one or more second devices of the second premises safety or automation system, and the one or more third devices of the third premises safety or automation system.

5. The control panel of claim 4, wherein the one or more processors, individually, as a subgroup, or in combination, are further configured to disconnect the second connection to cease supplying the battery backup power to the one or more second devices of the second premises safety or automation system upon expiration of the second standby time requirement, while keeping the first connection and the third connection to continue supplying the battery backup power to the one or more first devices of the first premises safety or automation system and the one or more third devices of the third premises safety or automation system.

6. The control panel of claim 5,
wherein the second premises safety or automation system comprises an access control system; and/or
wherein the third standby time requirement is less than the first standby time requirement.

7. The control panel of claim 6, wherein the one or more processors, individually, as a subgroup, or in combination, are further configured to disconnect the third connection to cease supplying the battery backup power to the one or more third devices of the third premises safety or automation system upon expiration of the third standby time requirement, while keeping the first connection to continue supplying the battery backup power to the one or more first devices of the first premises safety or automation system.

8. The control panel of claim 7,
wherein the first premises safety or automation system comprises an intrusion/security system and the third premises safety or automation system comprises a fire protection system; or
wherein the third premises safety or automation system comprises the intrusion/security system and the first premises safety or automation system comprises the fire protection system.

9. A control panel configured to control two or more premises safety or automation systems of a premises, the control panel comprising:
a first connection connectable to supply power to one or more first devices of a first premises safety or automation system having a first standby time requirement;
a second connection connectable to supply power to one or more second devices of a second premises safety or automation system having a second standby time requirement that is less than the first standby time requirement; and
one or more processors that, individually, as a subgroup, or in combination, are configured to:
enter a standby mode in which the first connection and the second connection supply battery backup power to the one or more first devices of the first premises safety or automation system and the one or more second devices of the second premises safety or automation system;
determine, upon expiration of the second standby time requirement, whether a current drawn by the second premises safety or automation system is greater than a threshold; and
disconnect the second connection to cease supplying the battery backup power to the one or more second devices of the second premises safety or automation system responsive to expiration of the second standby time requirement and the current being greater than the threshold, while keeping the first connection to continue supplying the battery backup power to the one or more first devices of the first premises safety or automation system.

10. The control panel of claim 9, wherein to determine whether the current drawn by the second premises safety or automation system is greater than the threshold, the one or more processors, individually, as a subgroup, or in combination, are configured to:
measure the current via a current measurement circuitry configured on a bus that supplies power to the second premises safety or automation system via the second connection; or deduce an estimate of the current by subtracting one or more measured currents from a total current supplied to one or more connections of the control panel.

11. The control panel of claim 9,
wherein the second premises safety or automation system comprises an access control system; and/or, wherein the first premises safety or automation system comprises an intrusion/security system or a fire protection system.

12. The control panel of claim 9, further comprising a third connection connectable to supply power to one or more third devices of a third premises safety or automation system having a third standby time requirement that is more than the second standby time requirement.

13. The control panel of claim 12, wherein the one or more processors, individually, as a subgroup, or in combination, are further configured to enter the standby mode in which the first connection, the second connection, and the third connection supply battery backup power to the one or more first devices of the first premises safety or automation system, the one or more second devices of the second premises safety or automation system, and the one or more third devices of the third premises safety or automation system.

14. The control panel of claim 13, wherein the one or more processors, individually, as a subgroup, or in combination, are further configured to disconnect the second connection to cease supplying the battery backup power to the one or more second devices of the second premises safety or automation system responsive to expiration of the second standby time requirement and the current being greater than the threshold, while keeping the first connection and the third connection to continue supplying the battery backup power to the one or more first devices of the first premises safety or automation system and the one or more third devices of the third premises safety or automation system.

15. A control panel configured to control two or more premises safety or automation systems of a premises, the control panel comprising:
a first connection connectable to supply power to one or more first devices of a first premises safety or automation system having a first standby time requirement;
a second connection connectable to supply power to one or more second devices of a second premises safety or automation system having a second standby time requirement equal to the first standby time requirement; and
one or more processors that, individually, as a subgroup, or in combination, are configured to:
enter a standby mode in which the first connection and the second connection supply battery backup power to the one or more first devices of the first premises safety or automation system and the one or more second devices of the second premises safety or automation system;
determine, upon expiration of the second standby time requirement, whether the first premises safety or automation system has a higher standby priority than the second premises safety or automation system;
disconnect the second connection, responsive to the first premises safety or automation system having the higher standby priority than the second premises safety or automation system, to cease supplying the battery backup power to the one or more second devices of the second premises safety or automation system, while keeping the first connection to continue supplying the battery backup power to the one or more first devices of the first premises safety or automation system; and
disconnect the first connection, responsive to the second premises safety or automation system having the higher standby priority than the first premises safety or automation system, to cease supplying the battery backup power to the one or more first devices of the first premises safety or automation system, while keeping the second connection to continue supplying the battery backup power to the one or more second devices of the second premises safety or automation system.

16. The control panel of claim 15,
wherein the first premises safety or automation system comprises an intrusion/security system and the second premises safety or automation system comprises a fire protection system; or
wherein the second premises safety or automation system comprises the intrusion/security system and the first premises safety or automation system comprises the fire protection system.

17. The control panel of claim 15, further comprising a third connection connectable to supply power to one or more third devices of a third premises safety or automation system having a third standby time requirement that is less than the first standby time requirement.

18. The control panel of claim 17, wherein the one or more processors, individually, as a subgroup, or in combination, are further configured to:
enter the standby mode in which the first connection, the second connection, and the third connection supply battery backup power to the one or more first devices of the first premises safety or automation system, the one or more second devices of the second premises safety or automation system, and the one or more third devices of the third premises safety or automation system; and
disconnect the third connection to cease supplying the battery backup power to the one or more third devices of the third premises safety or automation system responsive to expiration of the third standby time requirement, while keeping the first connection and the second connection to continue supplying the battery backup power to the one or more first devices of the first premises safety or automation system and the one or more second devices of the second premises safety or automation system.

19. The control panel of claim 17, wherein the one or more processors, individually, as a subgroup, or in combination, are further configured to:
enter the standby mode in which the first connection, the second connection, and the third connection supply battery backup power to the one or more first devices of the first premises safety or automation system, the one or more second devices of the second premises safety or automation system, and the one or more third devices of the third premises safety or automation system; and
disconnect the third connection to cease supplying the battery backup power to the one or more third devices of the third premises safety or automation system responsive to expiration of the third standby time requirement and a current drawn by the third connection being above a threshold, while keeping the first connection and the second connection to continue supplying the battery backup power to the one or more first devices of the first premises safety or automation system and the one or more second devices of the second premises safety or automation system.

20. The control panel of claim 15, wherein the one or more processors, individually, as a subgroup, or in combination, are configured to determine whether the first premises safety or automation system has the higher standby priority than the second premises safety or automation system, based on stored standby priority configuration information.
